(19) United States
(12) Patent Application Publication
(10) Pub. No.: US 2026/0261532 A1
(43) Pub. Date: Sep. 3, 2026

(54) INFORMATION PROCESSING SYSTEM, INFORMATION PROCESSING METHOD AND TERMINAL

(71) Applicant: Genki WATANABE, Tokyo (JP)

(72) Inventor: Genki WATANABE, Tokyo (JP)

(21) Appl. No.: 19/547,733

(22) Filed: Feb. 24, 2026

(30) Foreign Application Priority Data
Feb. 28, 2025 (JP) 2025-031567
Oct. 21, 2025 (JP) 2025-177026

(51) Int. Cl. H04L 51/02

(52) U.S. Cl. CPC H04L 51/02

(57) ABSTRACT

An information processing system includes an information processing apparatus and a terminal. The information processing apparatus transmits web content data to the terminal for displaying a first web page including an application screen and a first conversational AI serving as an interlocutor of a user. The web content data includes scripts executable by the terminal to transmit user input and display switching information. When the terminal receives a message and application data input by the user via the first web page, the information processing apparatus determines, based on the message and the application data, a second conversational AI from among plural types of conversational AIs to output an alternative response. The information processing apparatus switches the interlocutor from the first conversational AI to the second conversational AI and transmits information indicating the switch. The terminal then displays a second web page indicating that the interlocutor has been switched.

### CROSS-REFERENCE TO RELATED APPLICATIONS

This patent application is based on and claims priority pursuant to 35 U.S.C. § 119(a) to Japanese Patent Application Nos. 2025-031567 filed on Feb. 28, 2025, and 2025-177026, filed on Oct. 21, 2025, in the Japan Patent Office, the entire disclosure of each of which is hereby incorporated by reference herein.

### BACKGROUND

### Technical Field

The present disclosure relates to an information processing system, an information processing apparatus, an information processing method, a program, and a terminal.

### Related Art

Conventionally, computer systems have been devised that interact with users by automatically generating responses to messages such as questions from users and outputting the responses.

### SUMMARY

The present disclosure provides an information processing system comprising an information processing apparatus and a terminal. The information processing apparatus includes first circuitry configured to: transmit web content data to the terminal, the web content data is for display of a first web page including a screen of an application and for display of a second web page including one or more conversational AI, wherein the first web page includes a first conversational AI as an interlocutor of a user, the web content data includes a first script executable by the terminal to transmit a message input in the first web page to the information processing apparatus, and the web content data includes a second script executable by the terminal to display information indicating the interlocutor has been switched; receive a Hypertext Transfer Protocol (HTTP) request including the message input via the first web page and application data input in the application by the user, the HTTP request being transmitted in response to execution of the first script; determine a second conversational AI to output an alternative response to the message based on the message and the application data among a plurality of types of conversational AIs; switch the interlocutor from the first conversational AI to the second conversational AI; and transmit, to the terminal, an HTTP response including the information indicating that the interlocutor has been switched. The terminal includes second circuitry configured to: receive the web content data from the information processing apparatus; execute the first script; display the first web page for accepting input of the message and the information from the user based on the web content data; receive the application data from the user via the first web page; receive the message from the user via the first web page; transmit the HTTP request including the message and the application data in response to executing the first script included in the web content data; receive the HTTP response including the information indicating that the interlocutor has been switched; execute the second script; and display the second web page including an indication that the interlocutor has been switched based on the web content data and in response to execution of the second script.

### BRIEF DESCRIPTION OF THE DRAWINGS

A more complete appreciation of implementations of the present disclosure and many of the attendant advantages and features thereof can be readily obtained and understood from the following detailed description with reference to the accompanying drawings, wherein:

FIG. 1 illustrates a configuration of an information processing system in the first embodiment.

FIG. 2 illustrates an application screen in the first embodiment.

FIG. 3 illustrates a hardware configuration of the information processing apparatus 10 in the first embodiment.

FIG. 4 illustrates a functional configuration of the information processing system in the first embodiment.

FIG. 5 illustrates an agent information storage unit 121.

FIG. 6 illustrates a history information storage unit 123.

FIG. 7 illustrates a processing procedure executed by the information processing system in the first embodiment.

FIG. 8 illustrates an interactive screen displayed at the start of a dialogue.

FIG. 9 illustrates an interactive screen display containing information for selecting a new execution agent.

FIG. 10 illustrates a modified example of the interactive screen containing information for selecting a new execution agent.

FIG. 11 illustrates an interactive screen that allows the user to select whether to switch the execution agent.

FIG. 12 illustrates an interactive screen of a display of final response information.

FIG. 13 illustrates an interactive screen indicating the switching of the execution agent.

FIG. 14 illustrates a processing procedure executed by the information processing system in the second embodiment.

FIG. 15 illustrates an interactive screen display when switching the execution agent without having the user select it.

FIG. 16 illustrates a modified example of a screen configuration for interaction within an application screen.

FIG. 17 illustrates a functional configuration of terminal 20 in the third embodiment.

FIG. 18 illustrates a processing procedure concerning screen transitions in the third embodiment.

FIG. 19 illustrates display of an execution agent selection screen.

FIG. 20 illustrates an interactive screen 510 after message input.

FIG. 21 illustrates a screen after switching execution agents in the third embodiment.

FIG. 22 illustrates screen transitions for the application screen in the modified example of the third embodiment.

FIG. 23 illustrates the functional configuration of terminal 20, which has the functions of information processing apparatus 10.

### DETAILED DESCRIPTION

Disclosure of this specification is not intended to be limited to the specific terminology so selected and it is to be understood that each specific element includes all technical equivalents that have a similar function, operate in a similar manner, and achieve a similar result.

Referring now to the drawings, implementations of the present disclosure are described below. As used herein, the singular forms “a,” “an,” and “the” are intended to include the plural forms as well, unless the context clearly indicates otherwise. The term “connected/coupled” includes both direct connections and connections in which there are one or more intermediate connecting elements. For the sake of simplicity, identical or similar reference numerals denote identical or similar elements such as parts and materials having the same functions, and redundant descriptions thereof are omitted unless otherwise required.

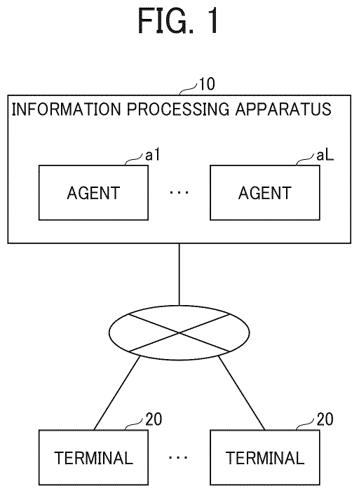

The following describes embodiments of the present disclosure based on the drawings. FIG. 1 is a diagram showing an example configuration of the information processing system in the first embodiment. In FIG. 1, one or more terminals 20 connect to an information processing apparatus 10 via a network such as a LAN (Local Area Network) or the Internet. The information processing apparatus 10 is one or more computers functioning as multiple types of agents a1 to aL that interact with users using AI (Artificial Intelligence). The agents are examples of conversational AI and appear to users as personified virtual entities serving as conversation partners (interlocutor). Conversation with the conversational AI (conversation partner) refers to the process where a user inputs a message, and a response is output. Specifically, the agent receives messages input by the user from terminal 20 and outputs the corresponding response to terminal 20. Messages input by the user may be questions, instructions or requests, and other input information requiring a response. The response is text containing information corresponding to the message. As a response to the message, this text may be output as speech. The agent may also be referred to as an automatic response means, AI agent, digital clone, personalized AI, AI assistant, automatic response AI, conversation partner, AI chatbot, companion, concierge, and virtual dialogue interface. The agent may also be a virtual human displayed as a conversation partner on a screen of terminal 20 as a 3D avatar modeled after a person.

In this embodiment, the information processing apparatus 10 functions as multiple types of agents. The multiple types of agents are distinguished by how they control the generation of responses to messages, among other characteristics. Furthermore, the roles of the multiple types of agents differ for each agent and are distinguished by their purpose or application, among other factors or characteristics. For example, roles of agents include inquiry (question-answering), comparison, classification, prediction, document generation, document supplementation, document evaluation, etc. Agents may be defined for each of these roles, or agents corresponding to other roles may be defined.

The user can select an agent suitable for their purpose or use from among the multiple types of agents as an interlocutor. Furthermore, the information processing apparatus 10, in response to the progress of the dialogue, if it determines that one or more agents are more suitable than the current agent for a message from the user, presents one or more agents more suitable than the current agent to the user. The information processing apparatus 10 can switch the agent serving as the dialogue partner to the agent selected by the user from among the presented agents.

The terminal 20 is a device functioning as the user interface of the information processing system. For example, a PC (Personal Computer), smartphone, or tablet terminal may be used as the terminal 20. The terminal 20 accepts message input from the user and transmits the message to information processing apparatus 10. The terminal 20 also receives and displays the response generated by the information processing apparatus 10 in response to the message. The terminal 20 may output the received information via a projector or similar device.

In this embodiment, a selection of an execution agent and the dialogue between the user and the agent are performed using a portion of the screen of an application (hereinafter referred to as the “app screen”) that is running on the terminal 20 (i.e., an application the user is currently using or operating).

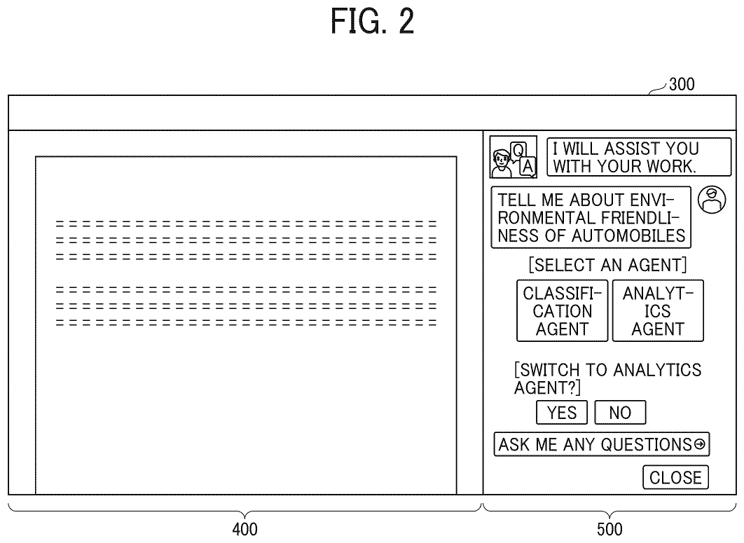

FIG. 2 is an example of an application screen 300 in the first embodiment. In FIG. 2, the app screen 300 includes a content area 400 and an interaction area 500. Content area 400 is the area displaying the data (content) being processed by the application. Examples of applications include presentation creation apps, document creation apps, spreadsheet apps, web conferencing apps, web browsers, and web apps displayed in a web browser. The content displayed in the content area 400 varies depending on the application, but examples include slides, documents, tables, web conference images, web pages, and web app screens. The interaction area 500 is an area for the user to interact with the agent. Messages entered by the user and responses from the agent are displayed here. FIG. 2 shows a state where the interaction is already in progress. However, at the start of the interaction, as described later, a list of agents available for selection as the interaction partner is displayed. The display of the interaction area 500 can be implemented by an add-in for the application (an add-in for the web application when the web application is displayed in a web browser). Note that the system configuration of the present disclosure, as shown in FIG. 1, communicates between the terminal 20 and the information processing apparatus 10 via a network, but is not limited to this. For example, web conferencing applications are often executed by communicating with a web conferencing application server. In such cases, the terminal 20 communicates with both the web conferencing application server and the information processing apparatus 10. The same applies to web browsers. That is, the terminal 20 communicates with an application server that supports the execution of applications on the terminal 20, which is different from the information processing apparatus 10, such as a web conferencing application server. Furthermore, the terminal 20 may communicates only with the application server without communicating with the information processing apparatus 10.

The application server then communicates with the information processing apparatus 10 to display a screen such as that shown in FIG. 2, allowing the present disclosure to be implemented while interacting with the interactive AI.

Furthermore, the application server and the information processing apparatus 10 may communicate with the terminal 20 as an integrated unit.

In this embodiment, the information processing system is assumed to be operated within a certain company (hereinafter referred to as “Company X”).

Therefore, users who can access the information processing apparatus 10 are employees of Company X or other persons belonging to Company X.

The services provided by the information processing apparatus 10 may be publicly available as cloud services.

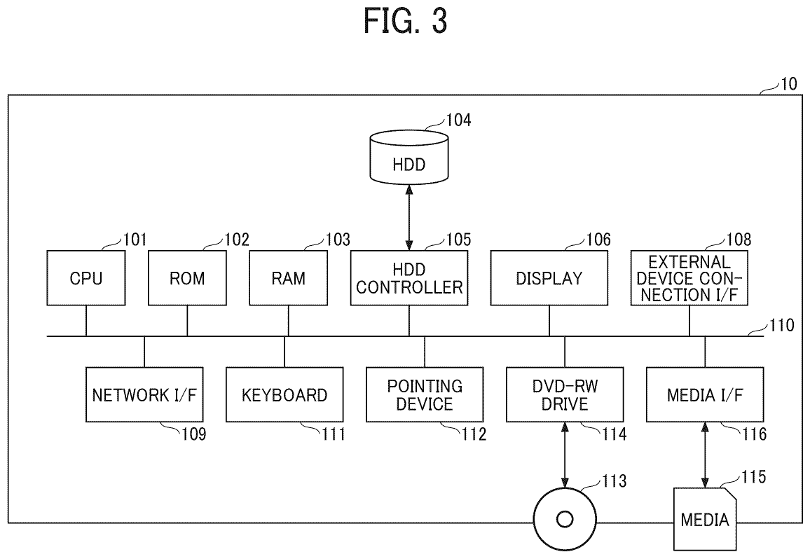

FIG. 3 is a diagram showing an example of the hardware configuration of the information processing apparatus 10 in the first embodiment. As shown in FIG. 3, the information processing apparatus 10 is constructed by a computer and includes a CPU (Central Processing Unit) 101, a ROM (Read Only Memory) 102, a RAM (Random Access Memory) 103, a HDD (Hard Disk Drive) 104, a HDD controller 105, a display 106, a external device connection I/F (Interface) 108, a network I/F 109, a data bus 110, a keyboard 111, a pointing device 112, a DVD-RW (Digital Versatile Disk Rewritable) drive 114, and a media I/F 116.

Among these, the CPU 101 controls the operation of the information processing apparatus 10. In an exemplary implementation, CPU 101 and other components of information processing apparatus 10 may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The ROM 102 stores programs used to drive the CPU 101, such as the IPL (Initial Program Loader). The RAM 103 is used as the work area for the CPU 101. The HDD 104 stores various data, such as programs. The HDD controller 105 controls the reading or writing of various data to the HDD 104 according to the control of the CPU 101. The display 106 displays various information such as cursors, menus, windows, characters, or images. The external device connection I/F 108 is an interface for connecting various external devices. In this case, the external devices include, for example, USB (Universal Serial Bus) memory and printer. ROM 102, RAM 103 and HDD 104 should be considered memory which may store a computer program including computer instructions. These computer instructions provide the logic and routines that enable the hardware (e.g., processing circuitry or circuitry) to perform the processes disclosed herein. This computer program can be stored in a computer-readable storage medium and may be implemented via a computer program product, a memory device, a recording medium and/or the memory of an FPGA or ASIC. The network I/F 109 is an interface for data communication using a communication network. The data bus 110 consists of address buses, data buses, etc., for electrically connecting components such as the CPU 101.

The keyboard 111 is a type of input device equipped with multiple keys for inputting characters, numeric values, various instructions, etc. The pointing device 112 is a type of input device used for selecting and executing various instructions, selecting processing targets, moving the cursor, etc. The DVD-RW drive 114 controls the reading and writing (storage) of various data to the DVD-RW 113, an example of a removable recording medium. Note that it is not limited to DVD-RW; it may also be a DVD-R, etc. The media I/F 116 controls the reading or writing (storage) of data to and from a recording medium 115, such as a flash memory.

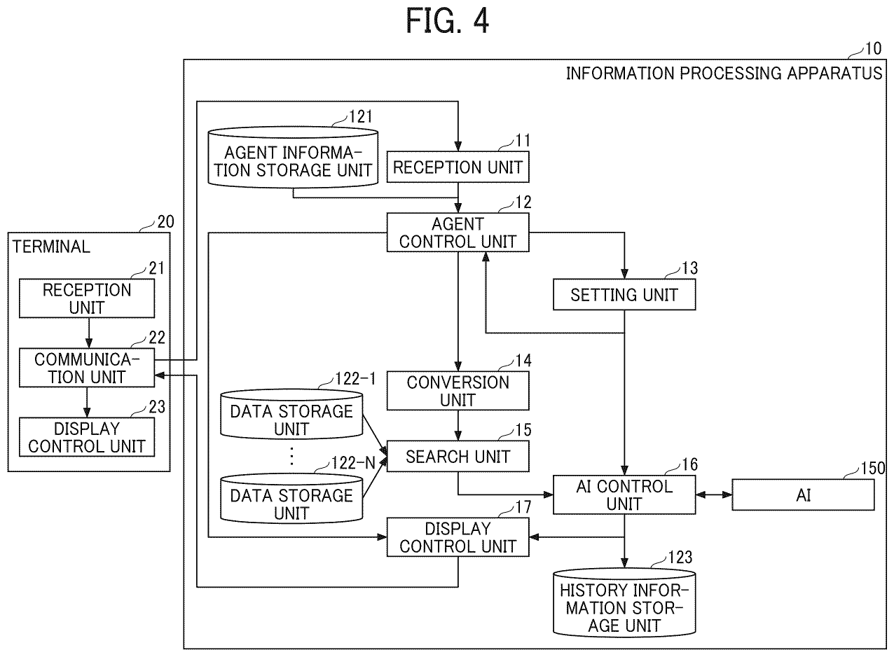

FIG. 4 is a diagram showing an example of the functional configuration of the information processing system in the first embodiment. In FIG. 4, the information processing apparatus 10 has an AI 150 and agents.

The AI 150 is a machine learning model (e.g., a neural network) trained to generate text (hereinafter referred to as a “response”) corresponding to input text (hereinafter referred to as a “prompt”). The AI 150 may also be trained to output responses that include images or files. The AI 150 generates, for example, text with the highest probability of occurrence as a response to a prompt based on its learning results. For example, a generative AI using a Large Language Model (LLM) may be employed as AI 150. The LLM is a machine learning model trained on natural language processing using vast amounts of text data. The LLM is used in many NLP (Natural Language Processing) tasks, such as generating responses to specific questions, automatically generating sentences, text summarization, translation, sentiment analysis, and many other NLP (Natural Language Processing) tasks. It can also be utilized for various applications such as education, entertainment, customer service, and product development. In this implementation, text including a message input by the user serves as the prompt. Note that the information processing apparatus 10 may not necessarily possess the AI 150. In this case, a publicly available generative AI on the internet or elsewhere may be used as the AI 150.

The AI 150 generates responses as an agent. Furthermore, The AI 150 may be prepared for multiple types of agents. In that case, when the user selects the first agent, the first AI corresponding to the first agent generates a response to the user's message. When the second agent is selected, the second AI corresponding to the second agent generates a response to the user's message.

Here, machine learning refers to the technology enabling computers to acquire human-like learning capabilities, whereby a computer autonomously generates algorithms necessary for judgments such as data identification from pre-incorporated training data and applies these to new data to make predictions. The learning method for machine learning may be any of supervised learning, unsupervised learning, semi-supervised learning, reinforcement learning, or deep learning. Furthermore, a learning method combining these approaches is also acceptable; the specific learning method for machine learning is not restricted.

The agent receives messages from the user and employs Retrieval Augmented Generation (RAG) to generate responses from the AI 150 for those messages. It also executes processing to include text previously generated by the AI 150 (responses output by the AI 150 to prompts previously input to the AI 150) within the prompt. Specifically, the agent is a set of functional units that perform these processes and includes the following functional units: a reception unit 11, an agent control unit 12, a setting unit 13, a conversion unit 14, a search unit 15, an AI control unit 16, and a display control unit 17. Each of these units is implemented by processing executed by one or more programs installed on the information processing apparatus 10 on the CPU 101. The agent also utilizes the following as storage units: an agent information storage unit 121, multiple data storage units 122-1 to 122-N, and a history information storage unit 123. Each of these storage units can be implemented, for example, using the HDD 104 or a storage device connectable to the information processing apparatus 10 via a network.

In this embodiment, it is noted that the information processing apparatus 10 functions as multiple types of the agents a1 to aL. However, the program functioning as the agent (hereinafter referred to as the “agent program”) may be common to each agent. The agent program causes the information processing apparatus 10 to function as multiple types of the agents based on information pre-set for each agent (hereinafter referred to as “agent information”).

The reception unit 11 accepts input from the user. For example, the reception unit 11 accepts selection from the user of an agent (hereinafter referred to as the “executing agent”) to serve as the dialogue partner from among the multiple types of agents a1 to aL. The reception unit 11 also accepts input of a message for the dialogue partner agent and accepts data (hereinafter referred to as “application data”) indicating the content entered into the application corresponding to the application screen 300 including the interaction area 500 where the message was input.

The message input is performed on the screen of the application the user is using.

The application data is input to the application the user is using. Input to the application refers to input for the operation of the application, separate from the message input to the interaction area 500. The message input has a separate input interface from the application data input. The messages are input to receive responses from the agent of the conversation partner and to give instructions to the agent. This differs from the application data input. App data may be editable.

In this case, the application data is also data accepted from the user. For example, in presentation creation apps, document creation apps, spreadsheet apps, web conferencing app, viewer app, web browser, or web app, the application data would be, respectively, presentation data, document data, spreadsheet data, web conference video and audio data, PDF and other file data being viewed, web pages, and data handled by the web app. The user input is performed on the terminal 20. Therefore, the reception unit 11 receives information corresponding to the input accepted by the terminal 20 from the terminal 20.

The agent control unit 12 controls the switching of the execution agent. When the execution agent is selected by the user, the agent control unit 12 executes processing to make the selected agent a1 the execution agent. When switching the executing agent according to the progress of the dialogue, the agent control unit 12 functions as an example of a determination unit that determines whether one or more agents a2 exist among the plural types of agents that can output a more appropriate response than the agent a1 (first dialogue AI), which is the current executing agent (dialogue partner) for the message received by the reception unit 11. At this time, the agent control unit 12 uses not only the message itself but also application data an example of content input into the application and displayed on the screen of the application to determine whether an agent capable of outputting a more appropriate response (i.e., an agent related to the content input into the application) exists.

If the agent control unit 12 determines that one or more agents a2 exist, it functions as an example of a switching unit that switches the dialogue partner to the selected agent a2 (second dialogue AI) from among the one or more agents a2. When switching an agent to the execution agent, the agent control unit 12 inputs the agent information of the execution agent stored for each agent in the agent information storage unit 121 into the setting unit 13. When switching the executing agent according to the progress of the dialogue, the agent control unit 12 performs processing to switch the executing agent based on the agent information stored for each agent in the agent information storage unit 121 and the message from the user.

The agent information stored for each agent includes text information indicating the role of the agent, identification information (hereinafter referred to as “data source ID”) of the data storage unit 122 corresponding to the agent, system prompts corresponding to the agent, and control rules corresponding to the agent.

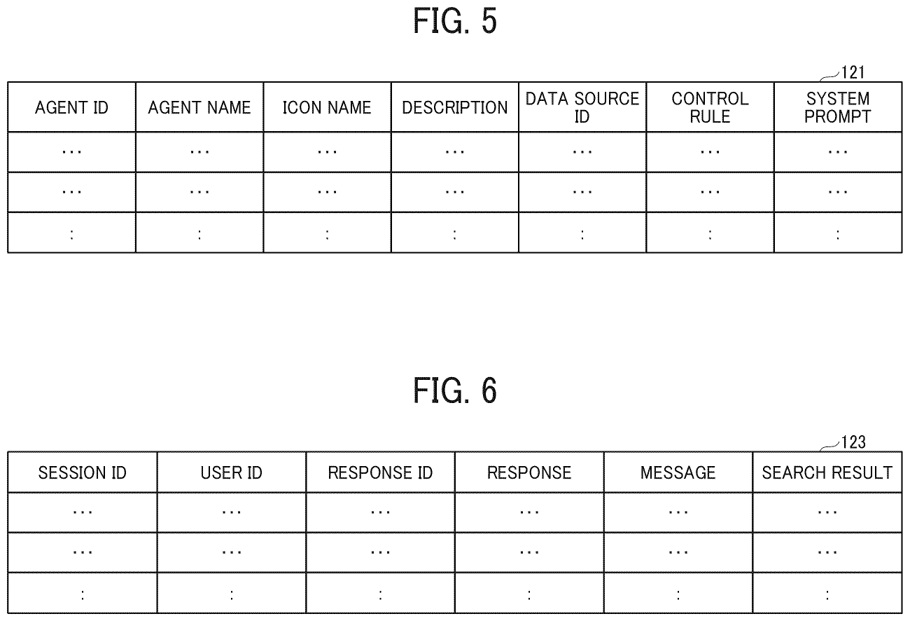

FIG. 5 is an example diagram of the agent information storage unit 121. As shown in FIG. 5, the agent information storage unit 121 pre-stores agent information for each agent that is a selection candidate. This information includes the agent ID, agent name, icon name, description, data source ID, control rule, and system prompts.

The agent name is the name of the agent. The icon name is the filename of the icon representing the agent.

The icon is displayed on the screen (interactive screen) for interaction between the user and the agent. The description is text data describing the role of agent, etc., in natural language. The data source ID is the identification information for the data storage unit 122 that the agent searches.

Two or more the data storage units 122 may be search targets. The control rules and system prompts are associating the AI control unit 16 with the agent. Control rules and system prompts are defined per agent, so multiple types of control rules and system prompts, differing from each other, are prepared in advance. Even when multiple agents search the same data source, applying different control rules to each agent yields different responses from each agent.

In other words, an agent's role is realized by its control rules and system prompts. For example, if an agent has the role of outputting query responses to user queries (questions) as a query agent, the description explaining that role, along with the control rules and system prompts to control the agent accordingly, are stored associated with that query agent. For an analytics agent whose role is to analyze data and output analysis results based on user instructions, the description explaining this role, along with control rules and system prompts to control the agent accordingly, are stored associated with that analytics agent.

A system prompt is a template (prototype) for prompts input to the AI 150, prepared in advance for each agent (role).

For example, by applying a system template to a message received by the reception unit 11, the prompt to be input to the AI 150 is generated.

Control rules are data that define the procedure for the input/output (interaction) of the AI 150 and are prepared in advance for each agent (role). To obtain a response appropriate to role of the executing agent for a message entered by a user, it may not suffice to input the prompt to the AI 150 just once in some case. For example, it may be necessary to have the AI 150 execute multiple tasks, such as extracting specific information, classification, prediction, or loop processing. In this case, prompts must be input for each task. However, information regarding what prompts should be input to the AI 150 and in what order (i.e., the procedure for interacting with the AI 150) is required. In this case, a prompt must be entered for each task. However, the data defining the information (namely, the procedure for interacting with AI 150) regarding what prompts should be entered and in what order is called a control rule. The interaction between the AI 150 and the user based on a single control rule is referred to as a “control procedure.” Within a control procedure, a single prompt input to the AI 150 is called a “phase.”

If a control procedure contains multiple phases, a system prompt corresponding to each phase is prepared. In this case, the message received by the reception unit 11 may be applied to the system prompt of a certain phase. The system prompts for other phases may correspond to responses obtained during the control procedure up to and including that phase. When distinguishing between responses obtained from the AI 150 during the control procedure and the final response obtained from the AI 150 at the end of the control procedure (i.e., the response to the message of the user), the former is called an “intermediate response” and the latter is called a “final response.” Furthermore, if only one prompt input is required during the control procedure, the control rule contains one phase and the system prompt is singular. In this case, there is no intermediate response, and the final response is obtained from a single prompt input.

The setting unit 13 performs settings on the AI control unit 16 and the search unit 15 to execute behaviors corresponding to the role of the executing agent for the AI control unit 16 and the search unit 15. These settings are based on the agent information of the executing agent input from the agent control unit 12. The switching of executing agents is achieved by switching the settings for the AI control unit 16 and the search unit 15.

The settings for the AI control unit 16 are switched for each agent because the system prompts and control rules differ for each agent. That is, the system prompts and control rules contained in the agent information of the executing agent are set for the AI control unit 16. On the other hand, the settings for the search unit 15 are switched for each agent because the data storage unit 122 used as the search target (source for acquiring document data) may differ for each agent. For example, agent a3, which handles legal knowledge, uses the data storage unit 122 containing legal document data as its search target, while agent a4, which handles accounting knowledge, uses the data storage unit 122 containing accounting document data as its search target. The data source ID contained in the agent information of the executing agent is set for the search unit 15.

When the reception unit 11 receives a message, the conversion unit 14 converts that message into a vector (hereinafter referred to as a “meaning vector”) that represents the meaning of the message in multiple dimensions using numerical values. The meaning vector can be generated using natural language processing such as BERT (Bidirectional Encoder Representations from Transformers). Hereinafter, the meaning vector generated by converting the message is referred to as the “message vector”. The search unit 15 uses the message vector generated by the conversion unit 14 to extract a subset of document data stored in the data storage unit 122 corresponding to the data source ID set by the setting unit 13. This subset consists of document data relatively highly relevant to the message. That is, the data storage unit 122 targeted for search (source of document data retrieval) by the search unit 15 changes according to the setting by the setting unit 13.

Each data storage unit 122 has document data related to various operations of the Company X pre-stored (registered). However, the set of document data stored differs for each data storage unit 122. This is because required document data varies depending on role of the agent. Therefore, the data storage units 122 may be prepared for each agent. Furthermore, some or all of the data storage units 122 may be used by two or more agents. The registration of document data to each data storage unit 122 may be performed in batches, or the user may upload the document data at any desired time. Each data storage unit 122 stores, for each document data registered therein, the document data itself and a semantic vector for each chunk of that document data. The chunk of the document data refers to a portion of the document data obtained by dividing the document data into predetermined units. The unit for dividing the document data may be the number of characters, the number of sentences, or a semantic unit (e.g., a paragraph, etc.), and it is sufficient if the data is pre-divided and stored by predetermined units. Hereinafter, the semantic vector for each chunk is referred to as a “chunk vector”.

The search unit 15 compares the message vector with the chunk vectors for each chunk of the document data in the data storage unit 122 being searched. It identifies the chunk associated with the chunk vector exhibiting the highest similarity for that document data (hereinafter referred to as the “similar chunk”). The search unit 15 compares the similarity among similar chunks for each document data item. It extracts the top M similar chunks. Consequently, essentially M document data items are extracted.

The similarity between vectors may be evaluated using cosine similarity or other metrics. The search unit 15 includes the top M similar chunks, IDs stored in the data storage unit 122 corresponding to these similar chunks (hereinafter referred to as “chunk IDs”), and IDs stored in the data storage unit 122 corresponding to the document data to which the similar chunks belong (hereinafter referred to as “document IDs”) and file names of the document data to which the similar chunks belong (hereinafter referred to as “document names”). Each data storage unit 122 may be a folder, a database, or any other management unit for a collection of document data.

The AI control unit 16 generates the prompt by applying the message received by the reception unit 11 and the set of similar chunks related to the search results from the search unit 15 to the system prompt set by the setting unit 13. Specifically, the AI control unit 16 generates the prompt by expanding the message received by the reception unit 11 with the set of similar chunks related to the search results from the search unit 15. The method of including the set of similar chunks related to the search results in the prompt may be the same as that of a known RAG. The text of each chunk belonging to the set of similar chunks related to the search results may be included in the prompt, or a vector generated based on the chunk vector of the chunk may be included in the prompt. An example of the system prompt is as follows.

### <Example of System Prompt>

The message from the user is as follows.

### {Message}

Please generate a response to the message using the following documents as reference.

### {Set of Similar Chunks Related to Search Results}

### <End of Example of System Prompt>

Thus, the system prompt defines sections for inserting the message and for inserting the set of similar chunks related to the search results generated by the search unit 15. In this case, the AI control unit 16 inserts the message received by the reception unit 11 into the {Message} section of the system prompt and inserts the set of similar chunks related to the search results generated by the search unit 15 into the {Set of similar chunks related to the search results} section to generate the prompt. By inputting the prompt generated in this manner to the AI 150, the AI 150 can generate a response utilizing knowledge (knowledge not learned by the AI 150) contained within the set of similar chunks related to the search results. That is, the response from the AI 150 can be based on the set of similar chunks related to the search results. Furthermore, the system prompt may include a string to notify the AI 150 of the agent's role corresponding to the system prompt, such as “You are XXX.” (where XXX is a string indicating the role).

Furthermore, when the control procedure includes multiple phases, a system prompt may be defined for a given phase that explicitly indicates where the intermediate response obtained in a phase preceding that phase (e.g., for the Kth phase, an intermediate response obtained in any phase from the 1st phase to the K−1st phase) is to be applied.

The AI control unit 16 also performs interactions with the AI 150 according to the control procedure based on control rules set by the setting unit 13.

The AI control unit 16 also interacts with the AI 150 according to the control procedure based on control rules set by the setting unit 13. For each phase of this control procedure, the AI control unit 16 generates the prompt based on the system prompt corresponding to that phase and sends this prompt to the AI 150. The AI control unit 16 then receives the response to this prompt from the AI 150.

Furthermore, whenever the final response is obtained from the AI 150, the AI control unit 16 associates the message and search results that led to that final response with the final response itself and stores them in the history information storage unit 123. The intermediate responses may also be stored associated with the final response.

Therefore, the history information storage unit 123 stores history information of the dialogue (input/output of the AI 150) between the user and the agent.

FIG. 6 is an example of the history information storage unit 123. As shown in FIG. 6, the history information storage unit 123 stores history information including a session ID, user ID, response ID, message, and search results for each final response from the AI 150. The session ID is a unique ID for each session. A session refers to a series of exchanges between the user and the agent, including messages and final responses (intermediate responses may also be included), occurring from the time the interactive screen 510 is displayed until it is closed. The same session ID is assigned to final responses output within the same session. The date in history information storage unit 123 may be stored in a table or database format, as shown in FIG. 6.

The user ID is identification information for the user who conducted the session (dialogue) associated with the session ID. The user ID may be identified by performing user authentication. The response ID is, for example, a unique ID for each final response, assigned when the AI control unit 16 records the final response in the history information storage unit 123. Messages and search results stored in the history information storage unit 123 are applied to the prompt that led to the final response.

The display control unit 17 displays the agent, that is the dialogue partner of the user, in an identifiable manner on the screen (app screen 300) of the application used by the user. Specifically, the display control unit 17 sends display content to be displayed in the interaction area 500 of the application screen 300 to the terminal 20.

The terminal 20 displays a interactive screen, etc., in the interaction area 500 based on a display content. The display control unit 17 further displays information including the final response received by the AI control unit 16 (hereinafter referred to as “final response information”) on the terminal 20 that sent the message. The final response information includes not only the final response but also information indicating the document data to which each similar chunk pertaining to the search results from the search unit 15 belongs. Therefore, the user can confirm what document data the final response was generated based on.

The display control unit 17 also displays one or more agents on the terminal 20 for selection when the agent control unit 12 determines that one or more agents exist that can output a more appropriate response than the execution agent.

The display control unit 17 further displays on the terminal 20, in a manner identifiable to the user, that the dialogue partner has been switched when the execution agent is switched.

The terminal 20 has a reception unit 21, a communication unit 22, and a display control unit 23. Each of these units is realized by processing executed by the CPU of the terminal 20 via a program installed on the terminal 20. The reception unit 21 receives user operations directed at the terminal 20. The communication unit 22 controls communication with the information processing apparatus 10. The display control unit 23 controls the display of screens (e.g., the interactive screen 510 described later) based on information (display content) received from the information processing apparatus 10.

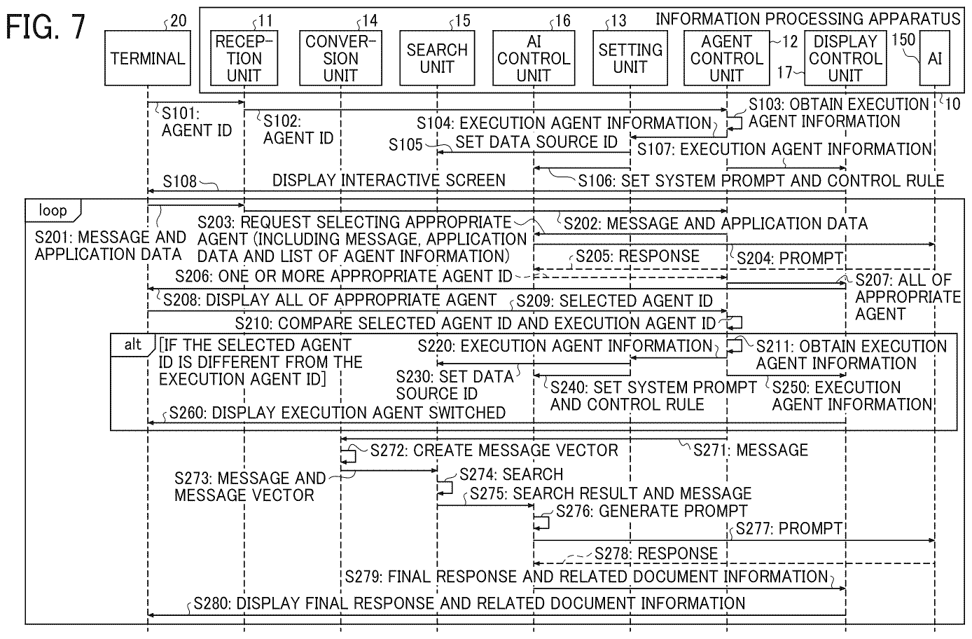

The following describes the processing steps executed by the information processing system. FIG. 7 illustrates an example of the processing steps executed by the information processing system in the first embodiment. At the start of the processing steps in FIG. 7, the user utilizes the interaction area 500 of the application screen 300 displayed on the terminal 20 to perform a login operation (authenticated by information processing apparatus 10) to the information processing apparatus 10. The interaction area 500 displays the execution agent selection screen. This screen displays a list of selectable agents.

The execution agent selection screen displays a list of selectable agents. This list may include agents sorted based on their roles (e.g., in alphabetical order of role-indicating strings). Additionally, some agents within this list may be searchable. In this case, the execution agent selection screen may allow input of search keywords, and agents with relatively high role similarity to the keyword may be displayed on the execution agent selection screen.

When any agent displayed on the execution agent selection screen is selected by the user, the terminal 20 sends identification information for the selected agent (hereinafter referred to as “agent ID”) to the information processing apparatus 10 (S101). In response to receiving this agent ID, the reception unit 11 of the information processing apparatus 10 inputs the agent ID to the agent control unit 12 (S102).

The agent control unit 12 acquires the agent information corresponding to the input agent ID from the agent information storage unit 121 (S103). Hereinafter, the agent information acquired in step S103 of FIG. 7 is referred to as “execution agent information”.

Next, the agent control unit 12 inputs the execution agent information to the setting unit 13 (S104). The setting unit 13 sets the data source ID of the input execution agent information to the search unit 15 (S105) and sets the control rules and system prompts for the execution agent information to the AI control unit 16 (S106). As a result, the search unit 15 searches the data storage unit 122 corresponding to the execution agent, and the AI control unit 16 executes the control procedure corresponding to the execution agent.

The agent control unit 12 also notifies the display control unit 17 of the execution agent information (S107). The display control unit 17 displays the interactive screen on the terminal 20, where the interactive partner is the agent (execution agent) associated with the execution agent information, within the interaction area 500 of the application screen 300 displayed on the terminal 20 (S108). Specifically, the display control unit 17 generates display data for the interactive screen and transmits this display data to the terminal 20 to display the interactive screen. The terminal 20 displays the interactive screen in the interaction area 500 based on this display data.

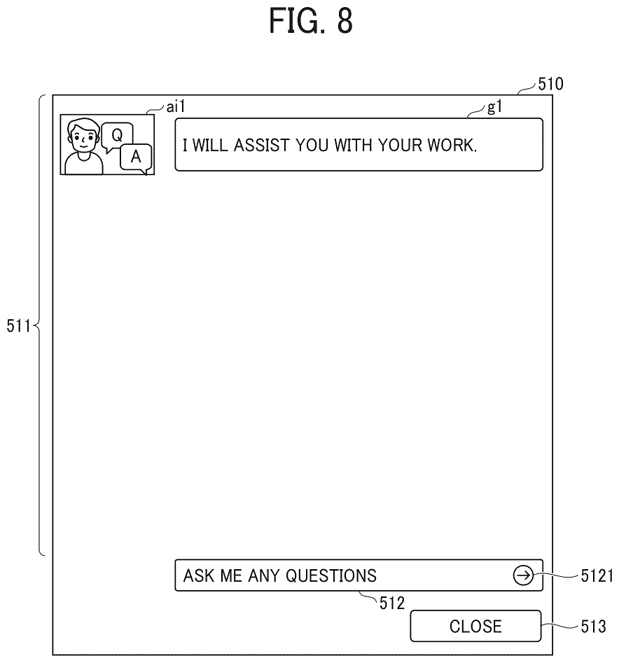

FIG. 8 is an example of the interactive screen display at the start of interaction.

The interactive screen 510 shown in FIG. 8 includes a conversation display area 511, a message input area 512, and a button 513, and is displayed in the interaction area 500 of the app screen 300 (FIG. 2). The conversation display area 511 is the area where the content of the dialogue between the execution agent and the user is displayed. In the initial state, the greeting message g1 (“I will assist you with your work.”) prompting the user to input a message. To the left of greeting text g1, the execution agent icon ai1 is displayed. The icon ai1 is an image stored in the file associated with the icon name in the execution agent information.

The user can visually recognize the current dialogue partner agent (i.e., the execution agent) through icon ai1. The message input area 512 is an area for accepting message input from the user and includes a send icon 5121. The button 513 is a button for accepting instructions to end the dialogue.

When the user inputs a message into the message input area and clicks the send icon 5121, the terminal 20 transmits the message (hereinafter referred to as the “target message”) and the application data (hereinafter referred to as “target application data”) of the application (hereinafter referred to as the “target app”) corresponding to the application screen 300 containing the interactive screen 510 where the message was entered in the interaction area 500 to the information processing apparatus 10 (S201).

At this time the data transmitted as the target application data is, for example, either: the entirety of the data being processed by the target app (including hidden portions); the portion of the data currently displayed; or the portion of the data selected by the user.

In response to receiving the target message and the target application data, the reception unit 11 inputs the target message and the target application data to the agent control unit 12 (S202). The agent control unit 12 inputs an agent selection request, containing the target message and the target application data along with a list of all agent information stored in the agent information storage unit 121, to the AI control unit 16 (S203). This selection request signifies a request to select one or more agents (hereinafter referred to as “appropriate agent”) who are more suitable than the execution agent for generating a response to the target message from the user currently using the target application data (viewing or editing it). Being more suitable than the execution agent for generating the response means being capable of outputting a more appropriate response than the execution agent.

The AI control unit 16 generates a prompt to instruct the AI 150 to select one or more appropriate agents. This prompt is based on the input target message, the target application data, a list of agent information, and a system prompt pre-prepared for selecting appropriate agents. The AI control unit 16 then sends this prompt generated to the AI 150 (S204). The prompt generated at this time is a prompt requesting the AI 150 to select one or more agents from multiple agents with different roles. These selected agents generate a more appropriate response than the execution agent to the message from the user who is currently using the target application data. In other words, it is a prompt that instructs the AI to determine the type of response the user is seeking based on the message input by the user currently using the target application data, and to select one or more agents capable of providing that type of response.

A simple example of the system prompt, which is the template for this prompt, is as follows:

### <Example of System Prompt Starts Here>

The message from the user is as follows.

### {Message}

The content displayed by the application this user is using to input the message is as follows.

### {App Data}

The candidate agents to respond to the above message are as follows.

### {List of Agent IDs and Agent Descriptions}

From the above agents, select all agents capable of outputting a more appropriate response to the above message than {Executing Agent}, considering the content displayed by the application the user is using.
Output the agent IDs of those agents.
<End of system prompt example>

In this case, the AI control unit 16 substitutes the target message into the {Message} part of the system prompt, substitutes the target application data into the {App Data} part, substitutes the agent ID and description (i.e., the role of the agent) for each agent into the {Agent ID and Agent Description List} part, and substitutes the agent ID of executing agent into the {Executing Agent} section to generate the prompt.

Note that the above system prompt instructs selecting “all” agents capable of outputting a more appropriate response than the executing agent. However, instead of “all” it may also be specified as “the top X agents.”

The target application data may be a portion of the information entered into the application and may be all of the information entered into the application. For example, in the case of a spreadsheet application, only the data displayed on the screen among the data entered into the application may be applied as the target application data, and all the data entered into the file being edited by the user in the spreadsheet application may be applied as the target application data.

The AI 150, having received the prompt generated as described above, selects one or more appropriate agents from among the agents listed within the prompt based on its learned parameters. It then generates a response containing the IDs of the selected agents. The AI 150 transmits this response to the AI control unit 16.

Next, the AI control unit 16 receives the response from the AI 150 (S205). This response contains the agent IDs of one or more agents selected as appropriate agents. Subsequently, the AI control unit 16 outputs each agent ID (hereinafter referred to as “appropriate agent ID”) of the one or more agents to the agent control unit 12 (S206).

The agent control unit 12 inputs all appropriate agent IDs output by the AI control unit 16 to the display control unit 17 (S207). Subsequently, the display control unit 17 generates display data for the interactive screen 510 containing display information for selecting one or more appropriate agents as the new execution agent (an agent to generate a response to the target message) and transmits the generated display data to display the generated screen in the interaction area 500 of the application screen 300 (FIG. 2) displayed on the terminal 20 (S208).

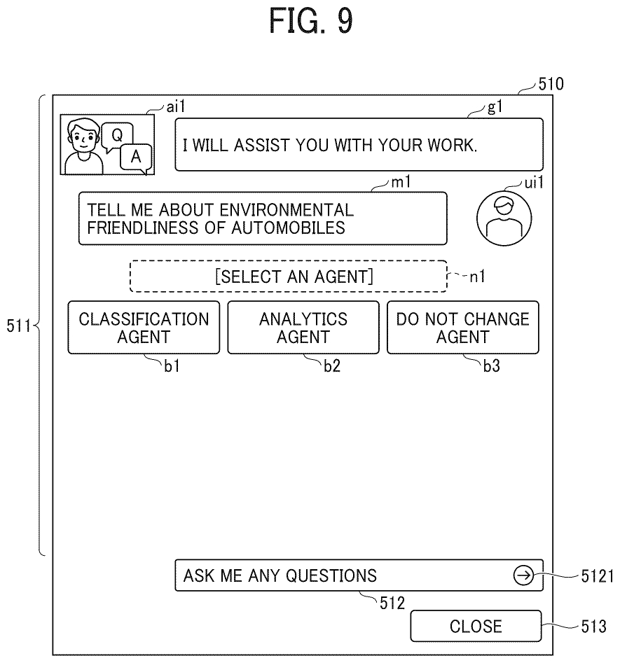

FIG. 9 is a display example of the interactive screen containing display information for selecting a new execution agent. In FIG. 9, identical parts to those in FIG. 8 are labeled with the same reference numerals, and their descriptions are omitted. In the interactive screen 510 shown in FIG. 9, a message m1, an icon ui1, an notification text n1, and a buttons b1 to b3 have been added. Note that the interactive screen 510 in FIG. 9 is also displayed in the interaction area 500 of the application screen 300 (FIG. 2).

Message m1 is the target message entered by the user in the message input area 512 during step S201. When the user clicks the send icon 5121, the target message entered in the message input area 512 is displayed in the conversation display area 511. Icon ui1 is the user's icon.

The notification text n1 and the buttons b1 to b3 are examples of display information for prompting the user to select a new executing agent from one or more appropriate agents. The notification text n1 is a notification prompting the user to select an agent. The buttons b1 and b2 correspond to each appropriate agent and are buttons for selecting the corresponding appropriate agent as the new execution agent. FIG. 9 includes two buttons to correspond to an example with two appropriate agents. The button b3 is a button for selecting not to change the execution agent.

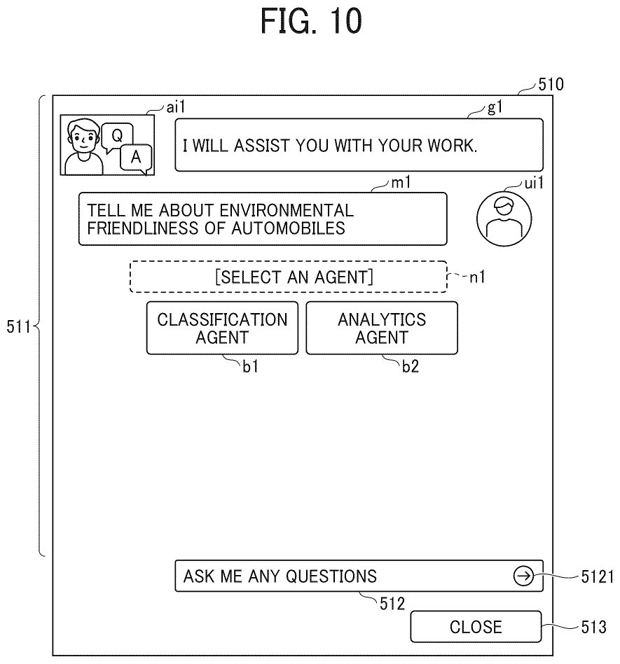

FIG. 10 shows a modified example of the interactive screen containing display information for selecting the new execution agent. In FIG. 10, identical parts to those in FIG. 9 are labeled with the same reference numerals, and their descriptions are omitted. The interactive screen 510 in FIG. 10 is also displayed in the interaction area 500 of the application screen 300 (FIG. 2). Interactive screen 510 in FIG. 10 does not include the button b3. Thus, it is possible to configure the system so that the user cannot choose not to change the execution agent.

When the user selects any of the buttons b1 to b3, the terminal 20 sends the agent ID (hereinafter referred to as the “selected agent ID”) of the agent corresponding to the selected button to the information processing apparatus 10 (S209). If the button b1 or b2 is selected, the agent ID of the appropriate agent corresponding to the selected button becomes the selected agent ID. If the button b3 is selected, the agent ID of the currently executing agent becomes the selected agent ID.

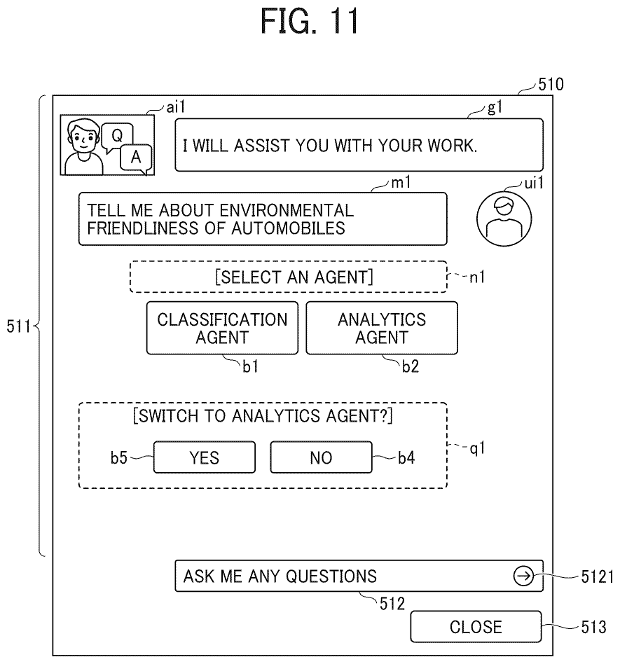

Furthermore, in FIG. 10, when the button b1 or b2 is selected, the terminal 20 may confirm with the user whether to switch the executing agent before transmitting the selected agent ID. FIG. 11 is an example of a display of the interactive screen that allows the user to select whether to switch the executing agent.

In FIG. 11, the same reference numerals are used for the same parts as in FIG. 10, and their descriptions are omitted. The interactive screen 510 in FIG. 11 is also displayed in the interaction area 500 of the application screen 300 (FIG. 2). The interactive screen 510 in FIG. 11 corresponds to the case where the button b2 is selected. It includes a text string indicating whether to switch to the analysis agent, along with buttons b5 and b4. The button b5 is a button for accepting the selection to switch. The button b4 is a button for accepting the selection not to switch.

In this case, if the button b5 is selected, the terminal 20 transmits the selected agent ID to the information processing apparatus 10. If the button b4 is selected, the terminal 20 transmits the agent ID of the currently executing agent to the information processing apparatus 10.

When the agent control unit 12 receives the selected agent ID, the agent control unit 12 compares the selected agent ID with the agent ID (hereinafter referred to as the “executing agent ID”) of the executing agent obtained in step S103. This comparison determines whether an agent exists that can output a more appropriate response to the target message than the execution agent (S210).

If the selected agent ID and the execution agent ID are different, the agent control unit 12 determines that the agent exists that can output a more appropriate response to the target message than the execution agent. In this case, steps S211 to S260 are executed, and the execution agent is changed. If the selected agent ID and the execution agent ID are the same, the agent control unit 12 determines that no agent exists that can output a more appropriate response to the target message than the execution agent. In this case, steps S211 to S260 are not executed, and steps S271 and subsequent steps are executed.

First, the case where the selected agent ID and the executing agent ID are the same (when the button b3 in FIG. 9 is selected) is described. In step S271, the agent control unit 12 inputs the target message to the conversion unit 14. The conversion unit 14 generates the message vector by converting the input target message into the semantic vector (S272). Subsequently, the conversion unit 14 inputs the message vector (hereinafter referred to as the “target message vector”) and the target message to the search unit 15 (S273).

The search unit 15 searches for the data storage unit 122 corresponding to the data source ID set by the setting unit 13 (i.e., the data storage unit 122 corresponding to the execution agent) based on the input target message vector and the target message. The search unit 15 identifies similar chunks for each document data by comparing the input target message vector with the chunk vectors stored in the data storage unit 122 (i.e., the data storage unit 122 corresponding to the execution agent) associated with the data source ID set by the setting unit 13, both for the entire document data and for each chunk. It then extracts a subset of similar chunks with relatively high similarity to the target message (S274). For example, the top X similar chunks are extracted based on the similarity between the target message vector and the chunk vector. The search unit 15 generates a search result containing the related document information for each extracted similar chunk. Subsequently, the search unit 15 inputs the search result and the target message to the AI control unit 16 (S275).

The AI control unit 16 generates the prompt based on the input search results and the target message, and the control rules and system prompts set by the setting unit 13 (S276). Subsequently, the AI control unit 16 sends the prompt to the AI 150 (S277). The AI control unit 16 receives the response generated by the AI 150 that received the prompt from the AI 150 (S278). Note that depending on the control procedure, the first response may not be the final response, and the final response is obtained by repeating steps S276 to S278 multiple times.

In response to obtaining the final response, the AI control unit 16 records the final response in the history information storage unit 123, associating it with the target message and the relevant search result. Next, the AI control unit 16 inputs the final response information, including the final response (hereinafter referred to as the “target final response”) and the related document information from the search results, to the display control unit 17 (S279).

The display control unit 17 displays the input final response information (the target final response and the related document information) on the interactive screen 510 displayed at the terminal 20 (S280). Specifically, the display control unit 17 generates display data for the final response information and sends the generated display data to the terminal 20 to display the final response information on the interactive screen 510 displayed on the terminal 20.

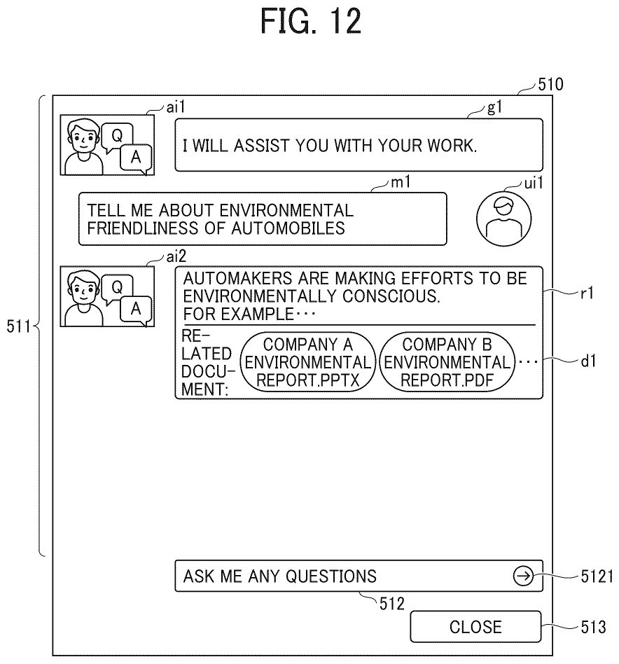

FIG. 12 is a diagram showing an example of displaying the final response information. In FIG. 12, the same reference numerals are used for the same parts as in FIG. 9, and their descriptions are omitted. The interactive screen 510 in FIG. 12 is also displayed in the interaction area 500 of the application screen 300 (FIG. 2). The interactive screen 510 shown in FIG. 12 has a response r1 and a related document information d1 have been added.

The response r1 is the target final response. The related document information d1 is document information related to the target final response. Therefore, the information including the response r1 and the related document information d1 constitutes the final response information for the message m1.FIG. 12 shows an example where a list of document names included in the related document information is displayed as the related document information d1. The target final response may be output split across multiple speech bubbles.

FIG. 12 also shows an icon ai2 added to the left of a response r1. The icon ai 2 is the icon of the executing agent that performed the final response. Here, since the executing agent has not switched, the icon ai2 is the same as the icon ai1. FIG. 12 shows an example where the notification text n1 and the buttons b1 to b3, which were displayed in FIG. 9, are removed. However, the notification text n1 and the buttons b1 to b3 may also be displayed in the interactive screen 510 of FIG. 12.

The user may either continue the dialogue or terminate it. To terminate the dialogue, the user clicks the button 513. In this case, the session ends, and the processing procedure of FIG. 7 terminates. To continue the dialogue, the user enters a new message in the message input area 512 and clicks the send icon 5121. In this case, the steps from step S201 onwards are repeated using the new message as the target message. That is, steps S201 onwards are repeatedly executed until the button 513 is clicked.

During the execution of steps S201 onwards, we describe the case where the selected agent ID and the executing agent ID differ. In this case, steps S211 to S260 are executed. In step S211, the agent control unit 12 acquires the agent information corresponding to the selected agent ID as the execution agent information from the agent information storage unit 121 (FIG. 5). In steps S220 to S250, processing identical to steps S104 to S107 is executed. In response to notification of a new execution agent information in step S250, the display control unit 17 causes the currently displayed interactive screen 510 to display information identifying that the execution agent has been switched (S260). Specifically, the display control unit 17 generates display data to display information identifying that the execution agent has been switched and transmits this display data to the terminal 20.

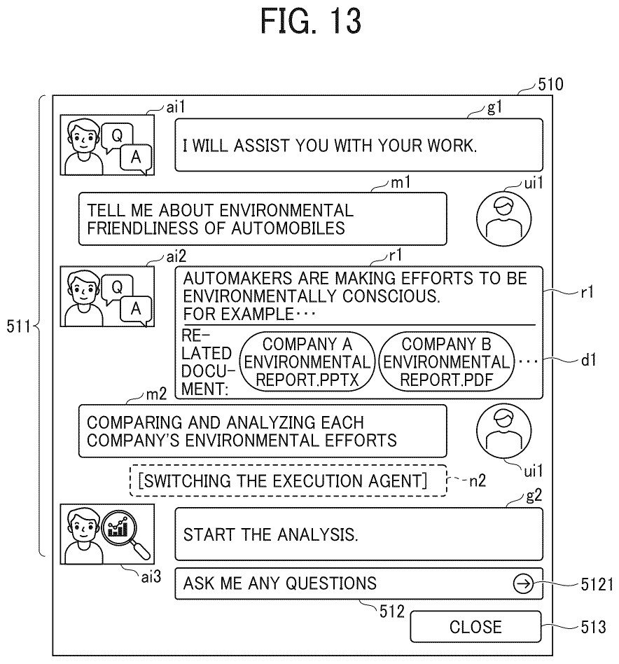

FIG. 13 is a diagram showing an example display of the interactive screen indicating the switching of the execution agent. In FIG. 13, identical parts to those in FIG. 12 are labeled with the same reference numerals, and their descriptions are omitted.

The interactive screen 510 in FIG. 13 is also displayed in the interaction area 500 of the application screen 300 (FIG. 2). In the interactive screen 510 shown in FIG. 13, a message m2, a notification n2, and a greeting g2 have been added. The message m2 is the new target message. FIG. 13 shows an example display when the appropriate agent for the message m2 was not the execution agent. Therefore, before displaying the notification n2 and the greeting g2, the information corresponding to the notification n1 and the buttons b1-b3 shown in FIG. 9 is displayed. When the button corresponding to the appropriate agent is selected, the interactive screen 510 in FIG. 13 is displayed.

The notification n2 and the greeting g2 are display information added in step S260 to notify the user of the execution agent switch. Furthermore, the icon ai3 to the left of the greeting text g2 differs from the icons ai1 and ai2 of the previous execution agents. The icon ai3 corresponds to the icon name contained within the agent information of the new execution agent. Thus, the switching of the icon also enables the user to identify the switch of the execution agent.

Following step S260 in FIG. 7, steps S271 and subsequent steps are executed. In this case, the search unit 15 searches for the agent information corresponding to the data source ID set in step S230 (S274). Furthermore, the AI control unit 16 executes steps S276 to S278 based on the control rules and system prompt set in step S240 to obtain the final response. As a result, a response based on document data different from that of the execution agent before the switch, and a response based on a system prompt (query method) different from that of the execution agent before the switch, are obtained as the final response. That is, a final response corresponding to the execution agent after the switch is obtained. Therefore, the possibility of outputting a more appropriate response to the message from the user increases.

As described above, according to the first embodiment, among multiple types of agents each having different roles, it is determined whether one or more agents (second agents) exist that can output a more appropriate response than the executing agent (first agent) to the message received from the user and the content displayed by the application the user is using. If such an agent exists, the one or more second agents become selectable and are displayed, and the executing agent is switched to the selected second agent. Consequently, switching to an agent outputting a more appropriate response to the message received from the user becomes possible. As a result, the quality of the response to the message received from the user can be improved. By determining the appropriate agent not only based on the message but also using application data, the appropriate agent can be determined while also considering the user's situation (what data the user is referencing or inputting) for the same message. For example, if the user is inputting data using a spreadsheet application, the likelihood of an agent analyzing data being selected as the appropriate agent can be increased.

In the above embodiment, in step S260 (FIG. 7), the notification text n1, the greeting text g2, and the icon ai3 shown in FIG. 13 were presented as examples of information identifying that the execution agent has been switched. However, this information may be realized in other forms. For example, in step S260, the display control unit 17 may display the agent name of execution agent instead of or in addition to the icon ai3. Alternatively, in step S260, the display control unit 17 may display a new interactive screen 510 on the terminal 20, separate from the currently displayed interactive screen 510, for interacting with the switched-over execution agent. As long as the switching of the execution agent is identifiable to the user, the display may be implemented in other forms.

Furthermore, in the above embodiments, the identification of the appropriate agent was shown as being achieved by the procedure indicated in steps S202 to S206 (FIG. 7). However, the appropriate agent may be identified by other procedures. For example, after determining whether the execution agent is suitable, the identification of the appropriate agent may be performed if the execution agent is unsuitable. This case is described as a second embodiment.

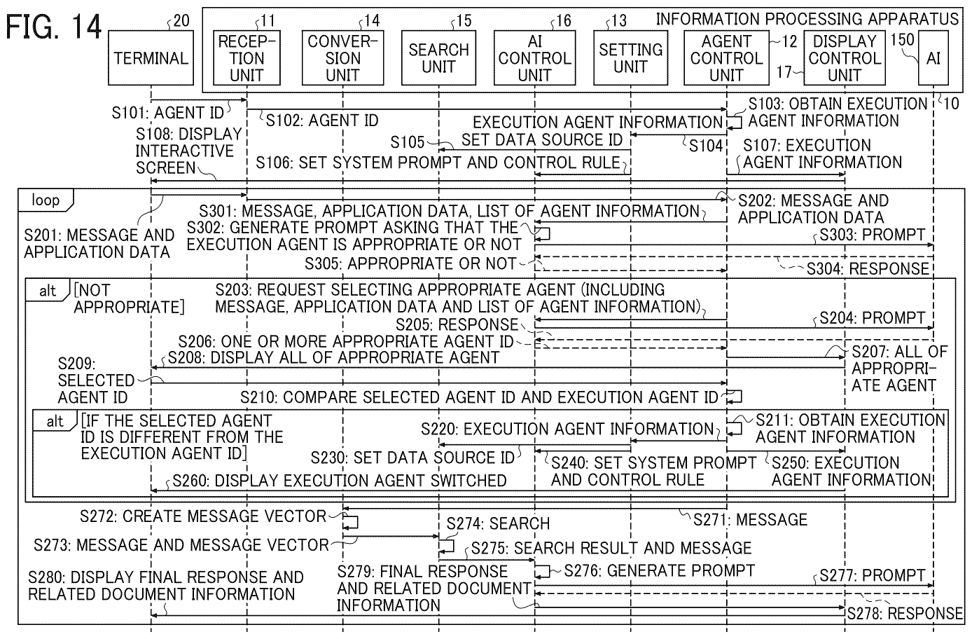

FIG. 14 illustrates an example of a processing procedure executed by the information processing system in the second embodiment. In FIG. 14, steps identical to those in FIG. 7 are assigned the same step number, and their descriptions are omitted. Following step S202, the agent control unit 12 inputs the target message and the target application data, along with the agent information of the current execution agent (execution agent information), to the AI control unit 16 (S301). The AI control unit 16 generates a prompt to inquire about the suitability of the executing agent using the target message, the target application data, and the description of the executing agent information (S302). For example, the prompt may be generated with content such as: “The executing agent performs the role indicated in the description, but is it suitable for responding to the target message from a user currently using the application displaying the target application data?” The AI control unit 16 sends this prompt to the AI 150 (S303) and receives a response from the AI 150 indicating whether the execution agent is suitable (S304). The AI control unit 16 outputs this response (i.e., the suitability of the execution agent) to the agent control unit 12 (S305). If the response indicates the execution agent is suitable, steps S202 to S260 are skipped, and steps S271 onwards are executed. If the response indicates that the execution agent is not suitable, then steps S202 and subsequent steps are executed. In this case, step S210 determines whether an agent different from the execution agent has been selected.

By preparing control rules for each agent in advance, it becomes possible to switch the conversation partner to another agent that can provide an appropriate response to the message based on the message input by the user. This is achieved by having the agent controlled by its control rules, which define the role of agent and capabilities. Furthermore, by determining whether to switch agents each time a message is received, even during an ongoing conversation with a conversational AI, if the appropriate conversational AI exists to respond to the message, the user can be presented with another conversational AI and the conversational AI can be switched. This allows the user to switch to a different conversational AI while continuing the conversation on the current screen, without needing to transition to other screens like a conversational AI selection screen.

In the above embodiments, examples were shown where the user selects the execution agent. However, the agent control unit 12 may automatically select the execution agent. In this case, the prompt in step S204 of FIG. 7 or FIG. 14 may be a prompt requesting to select one or more agents from multiple agents with different roles that generate the most appropriate response to the message from the user using the target application.

A simple example of the system prompt template for this prompt is as follows:

### <Example of System Prompt>

The message from the user is as follows:

### {Message}

The content displayed by the application this user is using to input the message is as follows:

### {App Data}

Candidate agents responding to the above message are as follows.

### {List of Agent IDs and the Agent Descriptions}

From the above agents, select the agent outputting the most appropriate response to the above message, considering the content displayed by the application the user is using.

Output that agent ID of agent.

<End of system prompt example>

In this case, steps S208 and S209 are not executed. If the agent ID output from the AI 150 differ from the agent ID of execution agent, steps S211 to S260 are executed. Therefore, when the target message is the message m1 in FIG. 9 and the executing agent is switched, the user is not given the opportunity to select the executing agent (the buttons b1 to b3 are not displayed), and the final response is displayed in step S280.

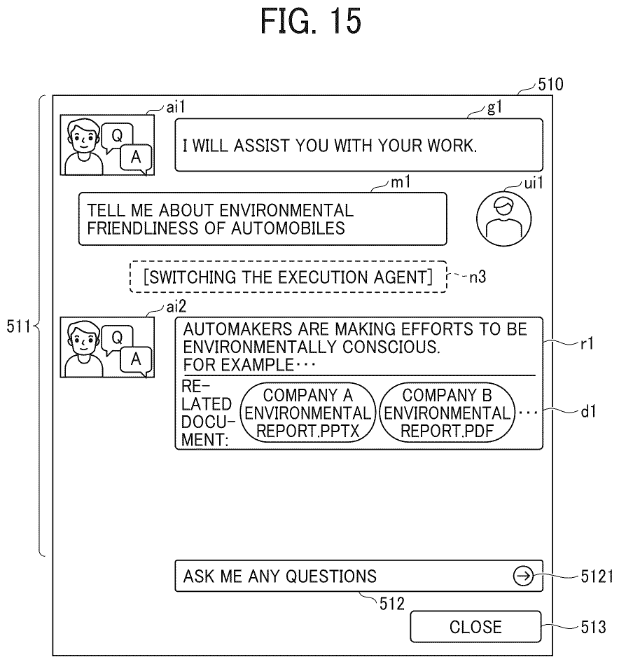

FIG. 15 is an example of a display of the interactive screen when switching the executing agent without allowing the user to select it. In FIG. 15, the same parts as in FIG. 12 are indicated by the same reference numerals, and their descriptions are omitted. The interactive screen 510 in FIG. 15 is also displayed in the interaction area 500 of the application screen 300 (FIG. 2). In FIG. 15, the notification text n3 is a display information added in step S260 to notify the user of the automatic switching of the execution agent.

Furthermore, when automatically switching the execution agent, as in FIG. 11, the user may be allowed to select whether to switch the execution agent. In the above embodiments, examples were shown where interaction between the user and the agent occurs in the interaction area 500. However, the screen configuration for interaction within the application screen 300 is not limited to this.

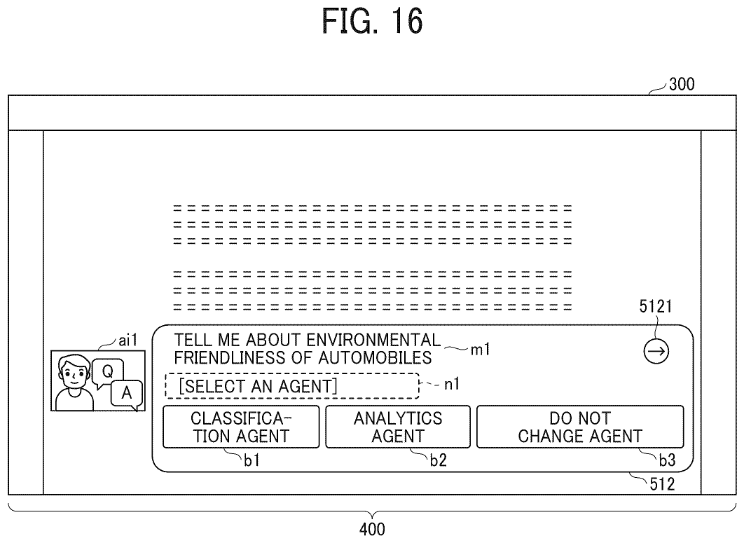

FIG. 16 is a diagram showing a modified example of a screen configuration for interaction within the app screen. In FIG. 16, identical or corresponding parts to those in FIG. 2 or FIG. 9 are labeled with the same reference numerals, and their descriptions are omitted as appropriate.

The application screen 300 in FIG. 16 does not include the interaction area 500. Instead, below of the content area 400, the application screen 300 includes a message input area 512. To the left of the message input area 512, the icon (the icon ai1 in FIG. 16) of the agent, who is the current interaction partner, is positioned. The message input area 512 displays not only messages entered by the user but also responses from the agent. The state of the message input area 512 in FIG. 16 corresponds to the state of the interactive screen 510 in FIG. 9. Specifically, the message input area 512 in FIG. 16 shows the state after the user entered the message m1 and clicked the send icon 5121, displaying the notification text n1 and the buttons b1 to b3. Note that responses from the agent may be displayed in the content area 400 instead of the message input area 512.

Thus, the screen configuration for interaction on the application screen 300 is not limited to any specific form. Interaction between the user and the agent may occur on the application screen 300 using configurations other than those exemplified in this embodiment. In such embodiment, for instance, when a message is input while interacting with the execution agent (first agent), if the user was inputting personnel regulations-related data as the application data within the application, the agent control unit 12 switches to a personnel regulations agent (second agent) that outputs a response related to the input data more appropriately than the first agent and outputs an appropriate response to the input message. Furthermore, when interacting with an execution agent (first agent), if the same message is input and the user was entering accounting-related data as the application data in the application, the agent control unit 12 switches to an accounting agent (the third agent), which outputs a response related to the input data and outputs an appropriate response to the input message.

Thus, even if the same message is input as the message to the execution agent, if the input application data is different, the determination is made based on the application data, allowing switching to a different agent each other. This is a feature of the present disclosure.

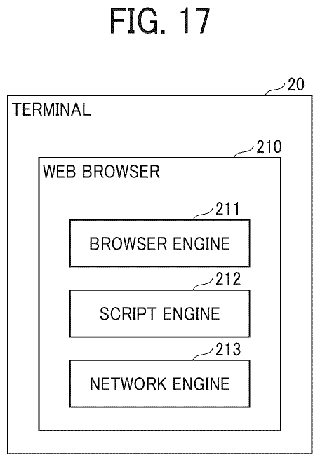

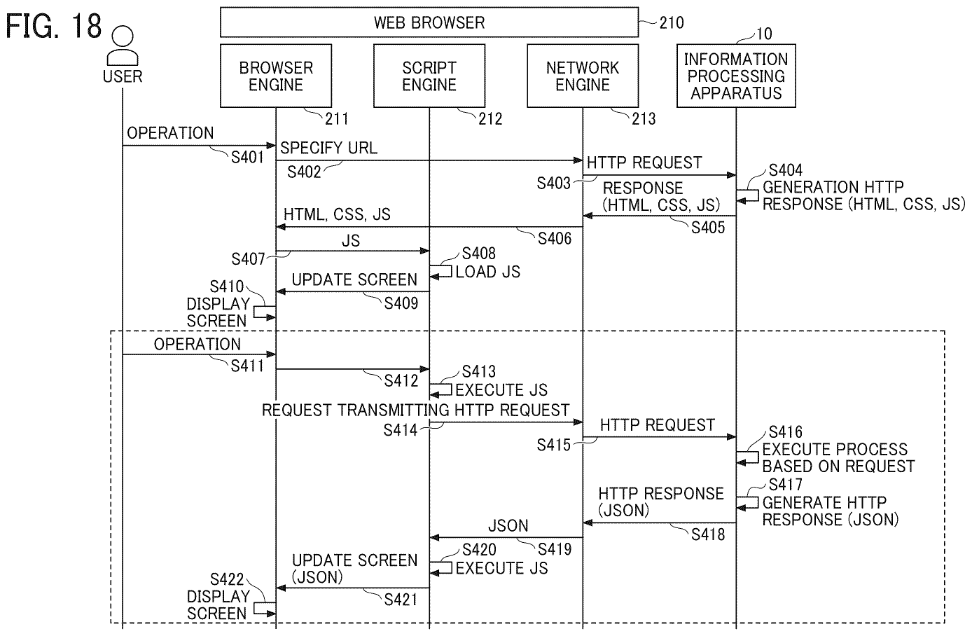

Next, the third embodiment is described. The third embodiment is an example where the terminal 20 displays various screens via a web browser, and the information processing device 10 functions as a web server executing web applications. FIG. 17 is a diagram showing an example of the functional configuration of the terminal 20 in the third embodiment. In FIG. 17, the terminal 20 has a web browser 210. The web browser 210 is a general web browser and includes a browser engine 211, a script engine 212, and a network engine 213. The browser engine 211 interprets HTML (Hyper Text Markup Language) data and CSS (Cascading Style Sheets) data that constitute a web page and displays the web page. The script engine 212 executes scripts (e.g., Java Script®) that constitute the web page. The network engine 213 sends HTTP requests and receives HTTP responses. FIG. 18 illustrates an example processing procedure for screen transitions in the third embodiment.

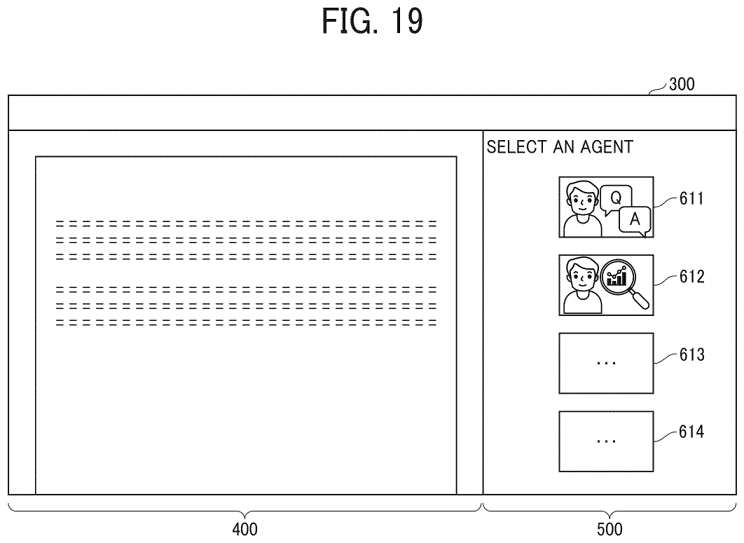

At the start of the processing procedure in FIG. 18, an execution agent selection screen is displayed in the web browser 210, which includes the interaction area 500 of the application screen 300 displayed on the terminal 20. FIG. 19 is a diagram showing an example of the execution agent selection screen display. As shown in FIG. 19, the execution agent selection screen displays icons 611 to 614 for each selectable agent. When the user selects one of the icons on the execution agent selection screen (S401), the browser engine 211 identifies the agent ID of the agent corresponding to the selected icon or the information identifying the selected icon as optional information.

When the user selects one of the icons on the execution agent selection screen (S401), the browser engine 211 inputs a URL into the network engine 213 that contains the agent ID of the agent corresponding to the selected icon or information identifying the selected icon as optional information, and that serves as the destination for an HTTP request to the information processing apparatus 10 (S402).

The network engine 213 sends the HTTP request to the destination URL (S403). The display control unit 17 of the information processing apparatus 10, in response to the HTTP request, generates an HTTP response containing web content data (HTML data, SS data, and script (hereinafter referred to as “JS”) corresponding to the URL to which the HTTP request is directed (S404). This web content is used to generate multiple web pages displayed subsequently.

Furthermore, the JS includes multiple JSs that execute processing corresponding to operations for each screen. Next, the display control unit 17 transmits the HTTP response generated in step S404 to the terminal 20 (S405). When the network engine 213 of the terminal 20 receives this HTTP response, the network engine 213 inputs the HTML data, CSS data, and JS contained in the HTTP response to the browser engine 212 (S406).

The browser engine 212 inputs the JS input from the network engine 213 to the script engine 212 (S407). The script engine 212 loads the JS (S408) and requests the browser engine 211 to update the screen (S409). The screen update includes displaying a new screen. Here, the HTTP response generated in step S404 may contain the JS filename rather than the JS entity itself. In this case, in step S408, the script engine 212 accesses the external file based on this filename and downloads the JS. This method involves loading JS as an external file. Subsequently, the browser engine 211 displays the interactive screen 510 in the interaction area 500 of the application screen 300 (FIG. 8) based on the HTML data and CSS data (S410). For example, if the icon 611 is selected on the execution agent selection screen, the interactive screen 510 shown in FIG. 8 is displayed in the interaction area 500 of the application screen 300 (FIG. 8).

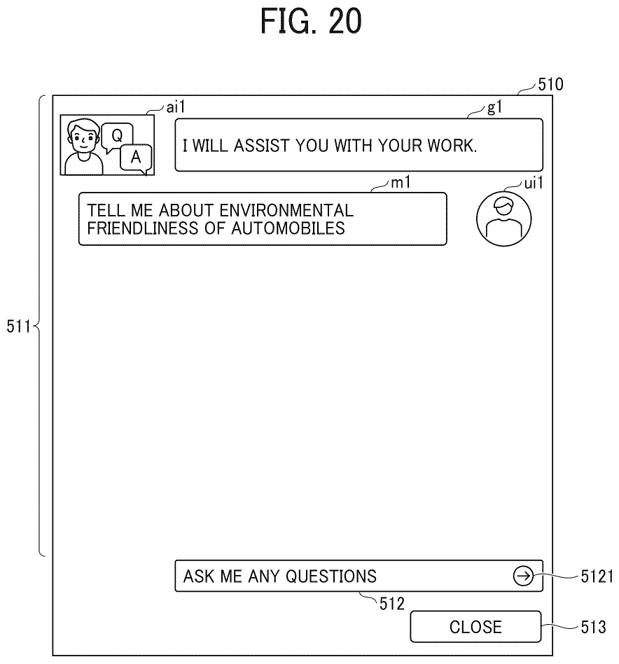

When the user inputs a message into the message input area 512 of the interactive screen 510 (FIG. 8) and clicks the send icon 5121 (S411), the display content of the interactive screen 510 changes as shown in FIG. 20. In FIG. 20, the message entered in the message input area 512 of FIG. 8 (hereinafter referred to as the “target message”) is displayed as the message m1 in the conversation display area 511, and an icon ui1 representing the user is added. Subsequently, the browser engine 211 executes the input of the target message and notifies the script engine 212 of the target message (S412).

The script engine 212, in response to the notification from the browser engine 211, executes one JS from among multiple JS that performs the transmission processing of the subject message and the application data of the subject app to the information processing apparatus 10 (S413). This results in the input to the network engine of the HTTP request sending request (S414). The HTTP request contains the subject message and the application data.

The network engine 213 sends the HTTP request, containing the target message and the application data, to the information processing apparatus 10 (S415). When the reception unit 11 of the information processing apparatus 10 receives the HTTP request, the information processing apparatus 10 executes the processing requested by the HTTP request (S416). For HTTP requests corresponding to the message input to the interactive screen 510 of FIG. 8, steps S202 to S207 of FIG. 7 are executed. As a result, one or more appropriate agent IDs for the target message and target application are obtained as the processing result.

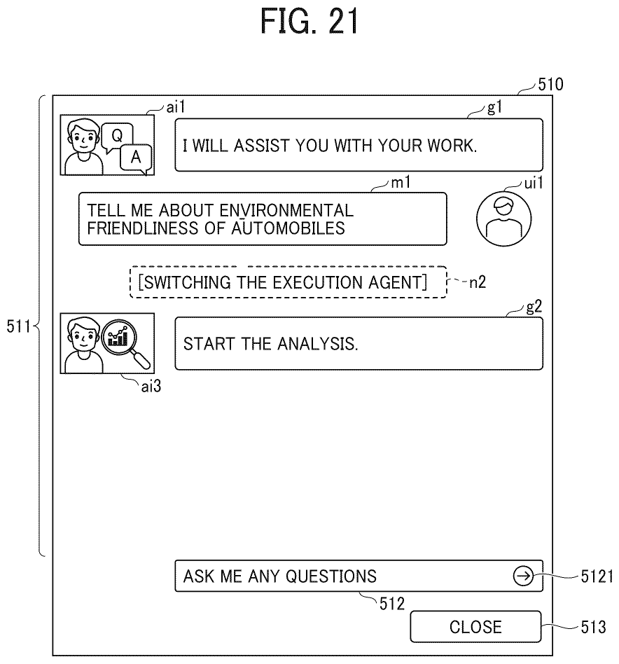

Subsequently, the display control unit 17 generates the HTTP response containing JSON (JavaScript Object Notation) describing all appropriate agent IDs as the processing result (S417). Then, the display control unit 17 transmits this HTTP response to the terminal 20 (S418). In response to receiving this HTTP response, the network engine 213 of the terminal 20 inputs the JSON contained within the HTTP response to the script engine 212 (S419). The script engine 212 executes a JavaScript (JS) from among a plurality of JSs, which updates the displayed content of the web page based on the JSON (S420), It then requests the browser engine 211 to update the displayed content of the web page based on the JSON (S421). The browser engine 211 updates the displayed content of the interactive screen 510 from the state shown in FIG. 9 to the state shown in FIG. 21 based on the HTML data and the CSS data and JSON obtained at S406. FIG. 21 shows the interactive screen 510. Compared to FIG. 9, the notification text n1 and the button b1 to b3 displayed in FIG. 9 have been removed, and the notification text n2, the greeting text g2, and the icon ai3 shown in FIG. 13 have been added.

That is, the notification text n2, the greeting text g2, and the icon ai3 are examples of information that identify that the execution agent has been switched, and the interactive screen 510 containing this identification information is an example of a screen after switching the execution agent. In the third embodiment, the agent control unit 12 may also automatically select the execution agent.

In this case, as shown in the interactive screen 510 of FIG. 20, step S412 to S422 of FIG. 18, which is executed in response to the message being input, is performed. At the time, S417, S202 to S207 of FIG. 7, S210 and S211 to S260 are executed. Therefore, in this case, Step S417 generates the HTTP response containing JSON describing information that enables identification of the executed agent switch. As a result, from the user's perspective, the display content of the interaction area 500 of the application screen 300 transitions from the interactive screen 510 of FIG. 9 to the interactive screen 510 of FIG. 21.

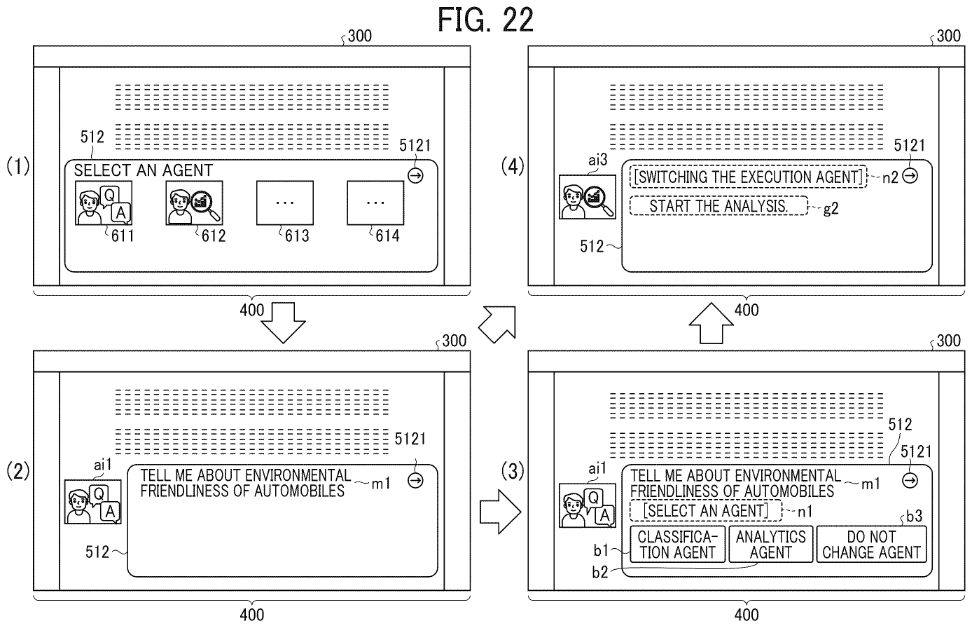

The third embodiment is also applicable when the application screen 300 has the layout shown in the modified example of FIG. 16. FIG. 22 is a diagram showing an example of screen transitions for the modified application screen in the third embodiment. In FIG. 22, the message input area 512 (1) corresponds to the execution agent selection screen of FIG. 19. The icon ai1 and message input area 512 (2), which is the transition destination from (1), correspond to the interactive screen 510 of FIG. 20.

The icon ai1 and the message input area 512 of (3) at transition destination from (2) correspond to the interactive screen 510 in FIG. 9. The icon ai3 and the message input area 512 (4) at transition destination from (3) correspond to the interactive screen 510 in FIG. 21. Note that, as described above, transition may occur from (2) to (4). As described above, in the third embodiment, a web content is a content data for displaying a first web page (e.g., FIG. 8) that accepts message input from the user and that also displays information identifying the first interactive AI, and a second web page (e.g., FIG. 21) that displays information identifying that the interactive partner has been switched.

The web content data, including the script is transmitted to the terminal 20. The script has execute a process for transmitting the message input on the first web page to the information processing apparatus 10, and a process for displaying the second web page showing the screen switched to the second conversational AI.

The HTTP request sent by executing the script on the terminal 20 contains the message entered on the first web page displayed on the terminal 20 based on the web content data. In response to receiving the HTTP request, the agent control unit 12, acting as a judgment unit, determines whether a second interactive AI exists among the plural types of interactive AIs that outputs a response more appropriate to the message than the first interactive AI, based on the message and the content entered into the application.

Furthermore, if it is determined that the second interactive AI exists, the display control unit 17 includes information in the HTTP response, which is the response to the HTTP request, to display to the terminal 20 in a manner that identifies that the interactive partner has been switched and transits the HTTP response to the terminal 20. Thus, the web content data, including the JS executing processing corresponding to operations on the first web page, the web pages (such as the second web page) displayed after screen transitions corresponding to that processing, and the JS executing processing corresponding to operations on each post-transition web page, is sent to the terminal 20 all at once in step S405. Since each screen transition is executed by JavaScript, the terminal 20 does not need to download the web content data again after the screen transition.

As a result, it is possible to expect solutions to technical issues such as improving the display speed of the second screen, etc., and reducing the communication load during screen transitions. The script engine 212 is an example of a script execution unit. The browser engine 211 is an example of a display control unit. The network engine 213 is an example of a transmission unit and a reception unit. In the above embodiments, the main functions of the information processing system were shown as being provided by the information processing apparatus 10. However, the terminal 20 may also provide the functions of the information processing apparatus 10.

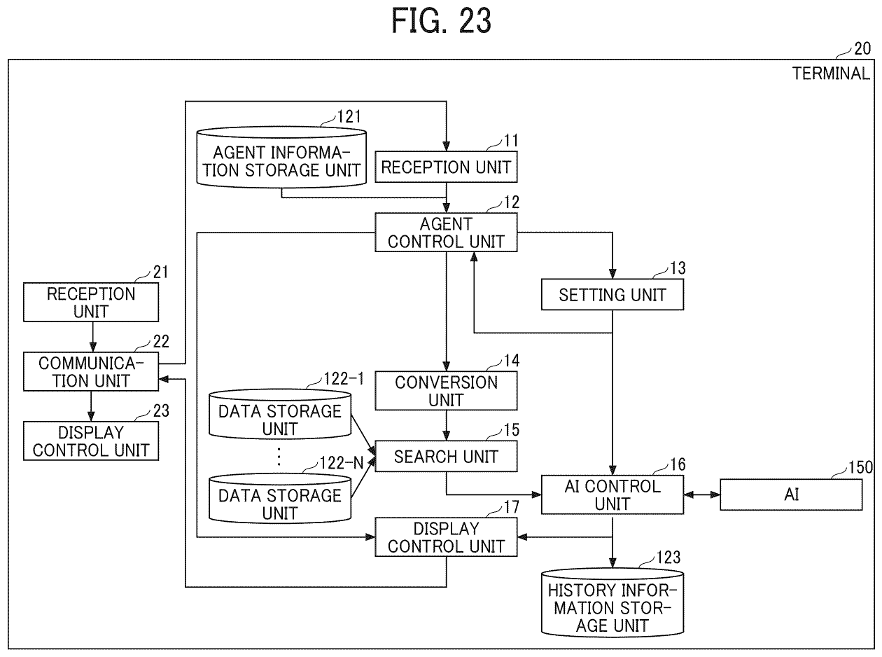

FIG. 23 is a diagram showing an example of the functional configuration of the terminal 20 equipped with the functions of information processing apparatus 10. In an exemplary implementation, terminal 20 may include a CPU such as that of information processing apparatus 10. The CPU controls the operation of terminal 20. The terminal may include circuitry or processing circuitry which performs the functionality of the functional configuration illustrated in FIG. 23. In FIG. 23, the same reference numerals are used for the same parts as in FIG. 4, and their descriptions are omitted. As described above, each functional configuration has functions similar to the functional configuration of FIG. 4 and executes processing similar to the sequence diagrams of FIGS. 7 and 14.

In FIG. 23, the functions provided by the information processing apparatus 10 in the above embodiments are realized by processing executed by one or more programs installed on the terminal 20 on the CPU of the terminal 20. Furthermore, the functions shown in FIG. 4 (or FIG. 23) need not be entirely possessed by either the information processing apparatus 10 or the terminal 20; each may possess a subset of the functions. When each possesses a subset of functions, the classification between the group of functions possessed by the information processing apparatus 10 and the group of functions possessed by the terminal 20 is not limited to any specific form.

For example, the processing S202 to S240 to identify the appropriate agent may be performed by the group of functions possessed by the terminal 20, and the processing S271 to S280 to create the final response may be performed by the group of functions possessed by the information processing apparatus 10.

The information processing apparatus 10 may be any apparatus having a communication function, which may be implemented by communication circuitry. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

The apparatuses or devices in the above embodiments are only illustrative of one of several computing environments for implementing the one or more embodiments disclosed herein.

In some embodiments, the information processing apparatus 10 includes multiple computing devices, such as a server cluster. The multiple computing devices are configured to communicate with one another via any type of communication link, including networks or shared memory, and perform the processing disclosed herein. The terminal 20 may also include multiple computing devices configured to communicate with one another.

The following non-limiting examples illustrate aspects of the present disclosure. According to a first aspect, an information processing system includes a display control unit, a reception unit, a determination unit and a switching unit. The display control unit displays a first interactive AI on a screen of an application which user operating, wherein the first interactive AI is a dialogue partner with the user among multiple types of interactive AI with different roles that interact with the user. The reception unit receives a messages input on a terminal directed at the interactive AI. The determination unit determines based on the message and the content input into the application, whether a second interactive AI exists that output a more appropriate response to the message than the first interactive AI. The switching unit switches to the second interactive AI as the dialogue partner when determined that the second interactive AI exists. The display control unit displays information indicating the dialogue partner has been switched on the screen.

According to a second aspect, in the information processing system of the first aspect, the display control unit displays the dialogue between the user and the interactive AI in a portion of the screen of application.

According to a third aspect, in the information processing system of the first aspect or second aspect, the display control unit, when it determined that one or more second interactive AIs exist, displays the second interactive AI in a selectable manner.

According to a fourth aspect, in the information processing system of the first aspect to third aspect, wherein each of the plural types of interactive AIs has a different prompt sent to the AI to generate a response to a message received by the reception unit.

According to a fifth aspect, in the information processing system of the fourth aspect, wherein each of the plural types of interactive AIs has a different source for acquiring document data to be included in the prompt.

According to a sixth aspect, in the information processing system of the first aspect to the fifth aspect, the determination unit determines based on the message and the content input into the application, which is the content displayed on the screen of application.

According to a seventh aspect, in the information processing system of the first aspect to the sixth aspect, whether the second interactive AI exists that output a more appropriate response than the first interactive AI and is related to the content input into the application.

According to an eighth aspect, in the information processing system of the first aspect to the seventh aspect, the display control unit displays information identifying the second interactive AI in response to the switching of the dialogue partner.

According to a nineth aspect, in the information processing system of the first aspect to the eighth aspect, the display control unit displays a message indicating that the dialogue partner has been switched in response to the dialogue partner being switched.

According to a tenth aspect, an information processing apparatus includes a display control unit, a reception unit, a determination unit and a switching unit. The display control unit displays a first interactive AI on a screen of an application which user operating, wherein the first interactive AI is a dialogue partner with the user among multiple types of interactive AI with different roles that interact with the user. The reception unit receives a messages input on a terminal directed at the interactive AI. The determination unit determines based on the message and the content input into the application, whether a second interactive AI exists that output a more appropriate response to the message than the first interactive AI. The switching unit switches to the second interactive AI as the dialogue partner when determined that the second interactive AI exists. The display control unit displays information indicating the dialogue partner has been switched on the screen.

According to an eleventh aspect, an information processing method executed by a computer, the method includes a first step of displaying, a second step of receiving, a third step of determining, a fourth step of switching and a fifth step of displaying. The first step of displaying includes displaying a first interactive AI on a screen of an application which user operating, wherein the first interactive AI is a dialogue partner with the user among multiple types of interactive AI with different roles that interact with the user. The second step of receiving includes receiving a messages input on a terminal directed at the interactive AI. The third step of determining includes determining based on the message and the content input into the application, whether a second interactive AI exists that output a more appropriate response to the message than the first interactive AI. The fourth step of switching includes switching to the second interactive AI as the dialogue partner when determined that the second interactive AI exists. The fifth step of displaying includes displaying information indicating the dialogue partner has been switched on the screen.

According to a twelfth aspect, a program executed by an information processing apparatus, the program includes a first step of displaying, a second step of receiving, a third step of determining, a fourth step of switching and a fifth step of displaying. The first step of displaying includes displaying a first interactive AI on a screen of an application which user operating, wherein the first interactive AI is a dialogue partner with the user among multiple types of interactive AI with different roles that interact with the user. The second step of receiving includes receiving a messages input on a terminal directed at the interactive AI. The third step of determining includes determining based on the message and the content input into the application, whether a second interactive AI exists that output a more appropriate response to the message than the first interactive AI. The fourth step of switching includes switching to the second interactive AI as the dialogue partner when determined that the second interactive AI exists. The fifth step of displaying includes displaying information indicating the dialogue partner has been switched on the screen.

According to a thirteen aspect, a information processing system includes a display control unit, a reception unit, a determination unit and a switching unit. The display control unit displays a first interactive AI on a screen of an application which user operating, wherein the first interactive AI is a dialogue partner with the user among multiple types of interactive AI with different roles that interact with the user. The reception unit receives a messages input on a terminal directed at the interactive AI. The determination unit determines based on the message and the content input into the application, whether a second interactive AI exists that output a more appropriate response to the message than the first interactive AI. The switching unit switches to the second interactive AI as the dialogue partner when determined that the second interactive AI exists. The display control unit displays information indicating the dialogue partner has been switched on the screen. The display control unit transmit web content data to a terminal, the web content data cause to display first web page which includes the first conversational AI and cause to display second web page includes information indicating the interlocutor has been switched. The web content data also includes first script that cause to transmit the message to the information apparatus and second script that cause to display the second web page. In response to receiving an HTTP request including the message input on the first web page transmitted by execution of the first script, the determination unit determines whether the second conversational AI exists among multiple types of conversational AIs that output a response more appropriate to the message than the first conversational AI, based on the message and content of application. The display control unit transmit an HTTP response including the information indicating the interlocutor has been switched to display the second web page by executing of the second script.

According to a fourteenth aspect, a terminal includes a display control unit, a reception unit, a determination unit and a switching unit. The display control unit displays a first interactive AI on a screen of an application which user operating, wherein the first interactive AI is a dialogue partner with the user among multiple types of interactive AI with different roles that interact with the user. The reception unit receives a messages input on a terminal directed at the interactive AI. The determination unit determines based on the message and the content input into the application, whether a second interactive AI exists that output a more appropriate response to the message than the first interactive AI. The switching unit switches to the second interactive AI as the dialogue partner when determined that the second interactive AI exists. The display control unit displays information indicating the dialogue partner has been switched on the screen.

According to a fifteen aspect, an information processing system comprises an information processing apparatus and a terminal. The information processing apparatus includes a display control unit, a reception unit, a determination unit and a switching unit. The display control unit displays a first interactive AI on a screen of an application which user operating, wherein the first interactive AI is a dialogue partner with the user among multiple types of interactive AI with different roles that interact with the user. The reception unit receives a messages input on a terminal directed at the interactive AI. The determination unit determines based on the message and the content input into the application, whether a second interactive AI exists that output a more appropriate response to the message than the first interactive AI. The switching unit switches to the second interactive AI as the dialogue partner when determined that the second interactive AI exists. The display control unit displays information indicating the dialogue partner has been switched on the screen. The display control unit transmit web content data to a terminal, the web content data cause to display first web page which includes the first conversational AI and cause to display second web page includes information indicating the interlocutor has been switched. The web content data also includes first script that cause to transmit the message to the information apparatus and second script that cause to display the second web page. In response to receiving an HTTP request including the message input on the first web page transmitted by execution of the first script, the determination unit determines whether the second conversational AI exists among multiple types of conversational AIs that output a response more appropriate to the message than the first conversational AI, based on the message and content of application. The display control unit transmit an HTTP response including the information indicating the interlocutor has been switched to display the second web page by executing of the second script. The terminal includes an execution unit, a display control unit, a transmission unit and reception unit. The execution unit executes the scripts included in the web content data. The display control unit display the first web page on the screen by executing the script. The reception unit receives the web content data. The transmission unit transmits the HTTP request including the message to the information processing apparatus. The reception unit receives the HTTP response including the information indicating the interlocutor has been switched. The display control unit displays the second web page including the information indicating the interlocutor has been switched by executing the script.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above. Although the embodiments of the present disclosure have been described in detail above, the disclosure is not limited to these specific embodiments. Various modifications and changes are possible within the scope of the essence of the disclosure as described in the appended claims.

1. An information processing system, comprising:
an information processing apparatus; and
a terminal, wherein
the information processing apparatus includes first circuitry configured to:
transmit web content data to the terminal, the web content data is for display of a first web page including a screen of an application and for display of a second web page including one or more conversational AI, wherein the first web page includes a first conversational AI as an interlocutor of a user, the web content data includes a first script executable by the terminal to transmit a message input in the first web page to the information processing apparatus, and the web content data includes a second script executable by the terminal to display information indicating the interlocutor has been switched;
receive a Hypertext Transfer Protocol (HTTP) request including the message input via the first web page and application data input in the application by the user, the HTTP request being transmitted in response to execution of the first script;
determine a second conversational AI to output an alternative response to the message based on the message and the application data among a plurality of types of conversational AIs;
switch the interlocutor from the first conversational AI to the second conversational AI; and
transmit, to the terminal, an HTTP response including the information indicating that the interlocutor has been switched;
the terminal includes second circuitry configured to:
receive the web content data from the information processing apparatus;
display the first web page for accepting input of the message and the information from the user based on the web content data;
receive the application data from the user via the first web page;
receive the message from the user via the first web page;
execute the first script;
transmit the HTTP request including the message and the application data in response to executing the first script included in the web content data;
receive the HTTP response including the information indicating that the interlocutor has been switched;
execute the second script; and
display the second web page including an indication that the interlocutor has been switched based on the web content data and in response to execution of the second script.

2. The information processing system according to claim 1, wherein the second circuitry is further configured to display the first web page including a conversation between the user and the first conversational AI.

3. The information processing system according to claim 1, wherein the first circuitry is further configured to determine one or more second conversational AI based on the message and the application data; and the second circuitry is further configured to display the one or more second conversational AI in a selectable manner.

4. The information processing system according to claim 1, wherein the first circuitry is further configured to:
store prompts different from each other, each corresponding to a different type of conversational AI of a plurality of types of conversational AIs; and
transmit one of the prompts corresponding to the second conversational AI to generate a response to the message.

5. The information processing system according to claim 1, wherein the first circuitry is further configured to:
store data sources corresponding to each of a plurality of types of conversational AIs; and
transmit one of the data sources corresponding to the second conversational AI to generate a response to the message.

6. The information processing system according to claim 1, wherein the first circuitry is further configured to determine the second conversational AI based on the message, the application data and the contents displayed on the first web page.

7. The information processing system according to claim 1, wherein the first circuitry is further configured to determine whether the second conversational AI related to the application data input in the application exists among a plurality of types of conversational AIs.

8. The information processing system according to claim 1, wherein the second circuitry is further configured to display identification information of the second conversational AI in the second web page, in response to switching the interlocutor.

9. The information processing system according to claim 1, wherein the second circuitry is further configured to display a message indicating the interlocutor is switched.

10. A terminal, comprising:
a memory storing an application; and
circuitry configured to:
display a first screen of the application which includes a first conversational AI as an interlocutor of a user;
receive input of application data from the user via the first screen;
receive a message from the user via the first screen;
determine a second conversational AI to output an alternative response to the message based on the message and the application data among a plurality of types of conversational AI;
switch the interlocutor from the first conversational AI to the second conversational AI; and
display a second screen including an indication that the interlocutor has been switched.

11. The information processing system according to claim 1, wherein the first circuitry is further configured to store agent information for each of the plurality of types of conversational AIs, the agent information including an agent identifier, an agent name, a description indicating a role of the conversational AI, and a system prompt corresponding to the conversational AI.

12. The information processing system according to claim 1, wherein the first circuitry is further configured to store control rules for each of the plurality of types of conversational AIs, wherein the control rules define a procedure for interaction with an artificial intelligence model to generate the response to the message.

13. The information processing system according to claim 12, wherein the procedure includes a plurality of phases, each phase corresponding to a prompt input to the artificial intelligence model.

14. The information processing system according to claim 1, wherein the first circuitry is further configured to store history information including a session identifier, a user identifier, a response identifier, the message, and search results associated with a response generated by the conversational AI.

15. The information processing system according to claim 14, wherein a same session identifier is assigned to responses output within a same session, the session comprising a series of exchanges between the user and the conversational AI from a time the first web page is displayed until the first web page is closed.

16. The information processing system according to claim 1, wherein the first circuitry is further configured to:
convert the message into a message vector representing a meaning of the message in multiple dimensions;
compare the message vector with chunk vectors corresponding to chunks of document data stored in a data storage unit; and
extract a subset of chunks having similarity to the message above a threshold as search results.

17. The information processing system according to claim 16, wherein the first circuitry is further configured to:
generate a prompt by inserting the message and the subset of chunks into a system prompt template; and
transmit the prompt to an artificial intelligence model to generate a response utilizing knowledge contained within the subset of chunks.

18. The information processing system according to claim 1, wherein the second circuitry is further configured to display final response information including a response to the message and related document information indicating document data on which the response is based.

19. The information processing system according to claim 1, wherein the second circuitry is further configured to:
display an icon representing the first conversational AI adjacent to content displayed by the first conversational AI on the first web page; and
display a different icon representing the second conversational AI adjacent to content displayed by the second conversational AI on the second web page after switching the interlocutor.

20. An information processing method, comprising:
transmitting web content data to a terminal, the web content data for display, by the terminal, of a first web page including a screen of an application and for display of a second web page including one or more conversational AI, wherein the first web page includes a first conversational AI as an interlocutor of a user, the web content data includes a first script executable by the terminal to transmit a message input in the first web page to an information processing apparatus, and the web content data includes a second script executable by the terminal to display information indicating that the interlocutor has been switched;
receiving a Hypertext Transfer Protocol (HTTP) request including the message input via the first web page and application data input in the application by the user, the HTTP request being transmitted in response to execution of the first script;
determining a second conversational AI to output an alternative response to the message based on the message and the application data among a plurality of types of conversational AIs;
switching the interlocutor from the first conversational AI to the second conversational AI; and
transmitting, to the terminal, an HTTP response including the information indicating that the interlocutor has been switched.
